(19) United States
(12) Patent Application Publication
(10) Pub. No.: US 2025/0171686 A1
(43) Pub. Date: May 29, 2025

(54) ROOM TEMPERATURE AMBIENT SYNTHESIS OF METAL-DOPED HALIDE PEROVSKITE NANOCRYSTALS

(71) Applicants: ECOLE POLYTECHNIQUE FEDERALE DE LAUSANNE (EPFL), Lausanne (CH); President and Fellows of Harvard College, Cambridge, MA, Cambridge, MA (US)

(72) Inventors: Sascha Feldmann, Lausanne (CH); Mateo Cardenes Wuttig, Zurich (CH); Zachary Vanorman, Grimisuat (CH)

(21) Appl. No.: 18/962,156

(22) Filed: Nov. 27, 2024

Related U.S. Application Data
(60) Provisional application No. 63/602,842, filed on Nov. 27, 2023.

(51) Int. Cl. C09K 11/66; C01G 21/00

(52) U.S. Cl. CPC C09K 11/665; C01G 21/006; C01P 2002/34; C01P 2002/54; C01P 2002/77; C01P 2002/84; C01P 2004/04; C01P 2006/60

(57) ABSTRACT

A method of preparing a composition including crystalline particles of a halide perovskite, a composition and a perovskite-based device including the same. The halide perovskite has a chemical formula ABX₃, wherein A is a monocation, B is selected from a combination of lead (II) and a dopant and X is selected from a halide.

### CROSS REFERENCE TO RELATED APPLICATIONS

This application claims the benefit of U.S. Provisional Application No. 63/602,842 filed Nov. 27, 2023, the contents of which are incorporated by reference in their entirety.

### BACKGROUND

Halide perovskite nanocrystals (HP NCs), also known as perovskite quantum dots, are an exciting class of materials due to their strong light absorption and emission, defect tolerance, and solution processability. The strong, inherent optoelectronic properties of HP NCs make them potentially useful for applications including lighting and displays, lasing, and light detection. Typical synthetic approaches of HP NCs use a hot injection synthesis method, where one precursor solution is injected into another at a high temperature (140-200° C.) under an inert atmosphere. Strongly quantum confined monodisperse HP NCs, i.e. with an edge length of about 3 nm to about 7 nm and a narrow size distribution are difficult to synthesize using traditional hot injection synthetic routes.

Therefore, there exists a need for strongly quantum confined HP NCs, having a narrow size distribution and methods of preparing the same.

### SUMMARY OF THE INVENTION

The invention is made in view of the aforementioned problems and drawbacks in the related art.

In its broadest sense, the invention provides a method of preparing a composition, a composition, said composition comprising crystalline particles of a halide perovskite, the halide perovskite having a chemical formula according to Formula (I) ABX₃, a perovskite-based device comprising the crystalline particles of a halide perovskite of Formula (I).

In one aspect, provided herein is a method of preparing a composition comprising crystalline particles of a first halide perovskite, the method comprising the steps of:
combining an A-site stock solution comprising:
   an A-site complex comprising an A-site precursor and an A-site complexing agent; and
   a first non-polar solvent;
with a B-site stock solution comprising:
   a B-site complex comprising a lead (II) halide, a dopant halide, a B-site complexing agent; and
   a second non-polar solvent;
in a third non-polar solvent, under conditions suitable for the formation of a first product mixture, comprising the crystalline particles of a first halide perovskite, the first halide perovskite having a chemical formula according to Formula I:

ABX₃ (I);
wherein:
   A is a monocation selected from a metallic element and a monocationic organic group;
   B is selected from a combination of Pb²⁺ and a dopant;
   X, independently at each occurrence, is a halide;
and further wherein:
   the A-site precursor is a salt of A, which is soluble in the first non-polar solvent;
   the A-site complexing agent and the B-site complexing agent are each selected from a molecule comprising at least one non-polar hydrocarbyl group and at least one polar group;
   the dopant is a dication of a metallic element or a trication of a metallic element.

In some embodiments, A is selected from the group consisting of Li⁺, Na⁺, K⁺, Rb⁺, and Cs⁺ or from the group consisting of methylammonium [(CH₃NH₃)⁺], formamidinium [(HC(NH₂)₂⁺], ethylammonium [(H₅C₂NH₃)⁺], butylammonium [(H₉C₄NH₃)⁺], and guanidinium [C(NH₂)₃⁺].

According to certain embodiments, the dopant is selected from the group consisting of Sn²⁺, Cd²⁺, Zn²⁺, Mn²⁺, Sr²⁺, Ni²⁺, Fe²⁺, Mn²⁺, Zn²⁺, Ni²⁺, Sr²⁺, Ca²⁺, Sm²⁺, Eu²⁺, and Co²⁺ or from the group consisting of Eu³⁺, Bi³⁺, In³⁺, Yb³⁺, Ce³⁺, Er³⁺, Sm³⁺, Eu³⁺, Tb³⁺, and Dy³⁺.

In further embodiments, the B-site stock solution comprises a combination of Pb²⁺ and a dopant in a molar ratio of Pb²⁺ relative to dopant of from about 95:5 to about 50:50.

In some embodiments, the halide perovskite comprises the dopant in an atomic ratio of from about 1:10000 to about 1:100 relative to Pb²⁺.

In further embodiments, X, independently at each occurrence, is selected from Cl, Br, and I, preferably from Cl and Br.

In some embodiments, the method is carried out at room temperature.

According to one embodiment, the method further comprises:
contacting the first product mixture with a halide exchange solution;
wherein the halide exchange solution comprises:
   a halide exchange reagent, the halide exchange reagent comprising an additional halide; and
a fourth non-polar solvent;
under conditions suitable to exchange at least one halide ion of the first halide perovskite with the additional halide;
thereby forming a second product mixture comprising crystalline particles of a second halide perovskite, wherein the second halide perovskite has a chemical formula according to Formula (I), and further wherein, each occurrence of X is the same halide.

In certain embodiments, the halide exchange reagent is selected from an oleylammonium halide and WCl₆. In particular, the halide exchange reagent is selected from oleylammonium chloride, oleylammonium bromide, oleylammonium iodide and WCl₆.

According to one embodiment, the second product mixture comprises the A-site complexing agent, the B-site complexing agent, and the second halide perovskite; and the method further comprises:
contacting the second product mixture with a ligand exchange solution, the ligand exchange solution comprising:
at least one ligand; and
a fifth non-polar solvent;
under conditions suitable to exchange the A-site complexing agent and/or the B-site complexing agent with the at least one ligand, thereby forming a third product mixture comprising ligated crystalline particles of the second halide perovskite;
wherein the ligated crystalline particles each have an outer surface, and each of the ligated crystalline particles further comprises at least one ligand bonded to the outer surface of the ligated crystalline particle.

In certain embodiments, the at least one ligand is a molecule comprising at least one non-polar hydrocarbyl group and at least one zwitterionic group.

According to certain embodiments, the at least one ligand is selected from the group consisting of long chain sulfobetaines, phosphocholines, phospholipids, long-chain alkylamines, and long-chain alkylacids. In particular, the at least one ligand is lecithin.

In other embodiments, the first non-polar solvent, second non-polar solvent, and third non-polar solvent are each independently selected from a C5-C10 hydrocarbon, or is a mixture thereof. The fourth non-polar solvent is independently selected from a C5-C10 hydrocarbon, or is a mixture thereof. The fifth non-polar solvent is independently selected from a C5-C10 hydrocarbon, or is a mixture thereof.

According to another embodiment, the method further comprises isolating the ligated crystalline particles from the third product mixture.

In another aspect, the invention provides a composition comprising ligated crystalline particles of a halide perovskite obtained according to the methods of the invention and having an edge length of less than about 9 nm.

In a further aspect, the invention proposes a perovskite-based device comprising ligated crystalline particles of a halide perovskite obtained according to the methods of the invention and being selected from an optoelectronic device, a photoelectrochemical device, a sensor, a nanoscale magnet and a quantum material-based spintronic device.

In certain embodiments, the perovskite-based device comprises the ligated crystalline particles of a halide perovskite having an edge length of less than about 9 nm.

This summary is not intended to identify key or essential features of the claimed subject matter, nor is it intended to be used as an aid in limiting the scope of the claimed subject matter. Further features and advantages of the invention will appear to those skilled in the art from the dependent claims and from the detailed description of preferred embodiments in relation to the appended drawings.

### BRIEF DESCRIPTION OF THE DRAWINGS

FIGS. 1A-1C show (A) a schematic describing the reaction of A-site and B-site precursors of doped halide perovskite being Cs salt, Mn salt, and Pb salt, and in respective complexing agents and non-polar solvents, which results in Mn-doped CsPbCl₃ nanocrystals, i.e. in crystalline particles of the nanometer order (NC=nanocrystal; TOPO=trioctylphosphine oxide; Oley-Cl=oleylammonium chloride, RT=room temperature). (B) UV-Vis absorption: Mn % numbers corresponds to mass % and (C) photoluminescence (PL) emission of three different sized nanocrystal series doped with different amounts of Mn.

FIGS. 2A-2D show TEM micrographs of (A) pristine (i.e., not doped or undoped) and (B) Mn-doped CsPbCl₃ NCs, as well as a histogram plotting edge lengths of (C) pristine (undoped) and (D) Mn-doped CsPbCl₃ NCs of a given size, taken from multiple TEM micrographs. FIG. 2C-2D showing the size distributions, the resulting mean size and standard deviation, confirm that no significant size changes upon doping occurs, even for small and confined NCs. Thus the metal dopant incorporation into nanocrystal lattice does not influence the size of metal-doped halide perovskite NCs.

FIG. 3A AND FIG. 3B show Normalized UV-Vis absorbance of Ni (A) and Zn (B) doped CsPbCl₃ NCs of varying sizes and doping concentrations.

FIG. 4 shows a schematic overview of an exemplary method of the disclosure to produce exemplary nanocrystalline CsPbCl₃ doped with Mn (HP NC=halide perovskite nanocrystal; TOPO=trioctylphosphine oxide; OlAmCl=oleylammonium chloride).

FIG. 5A and FIG. 5B show UV-Vis absorption (A) and photoluminescence (PL, B) emission data for exemplary nanocrystalline halide perovskite compositions of the disclosure at varying levels of Mn doping (Pb:Mn molar ratios of 100:0; 95:5; 90:10; 80:20; 75:25; or 50:50 in the B-site stock solution) synthesized with 120 μL of a 0.2 M TOPO stock solution. In both cases, the absorption and PL is normalized to the excitonic absorption/PL for each nanocrystalline sample. Increasing the amount of Mn dopant present results in an increased PL emission intensity of the characteristic Mn²⁺ spin-forbidden transition observed at approximately 600 nm. Upon Mn-doping, the characteristic excitonic absorption peak of the halide perovskite nanocrystal shifts from 393 nm, to ˜389 nm.

FIG. 6A and FIG. 6B show UV-Vis absorption (6A) and photoluminescence (PL, 6B) emission data for exemplary nanocrystalline halide perovskite compositions of the disclosure at varying levels of Mn doping (Pb:Mn ratios of 100:0; 95:5; 90:10; 80:20; 75:25; or 50:50) synthesized with 360 μL of a 0.2 M TOPO stock solution. In both cases, the absorption and PL is normalized to the excitonic absorption/PL for each nanocrystal. Increasing the amount of Mn dopant present results in an increased PL emission intensity of the characteristic Mn²⁺ spin-forbidden transition observed at approximately 600 nm. Upon Mn-doping, the characteristic excitonic absorption peak of the halide perovskite nanocrystal shifts from 402 nm, to ˜389 nm in the highest Mn-doping regimes.

FIG. 7 illustrates, further to the evidences shown in FIG. 2C-2D of metal dopant incorporation into nanocrystal lattice without influencing size, simulated (top line) and experimental (bottom line) X-band electron paramagnetic resonance data for 1.8% Mn-doped CsPbCl₃ NCs (corresponding to a molar ration Pb²⁺:Mn of 50:50 in the B-stock solution). The data were recorded at room temperature and confirmed the dopant incorporation into the host crystal lattice.

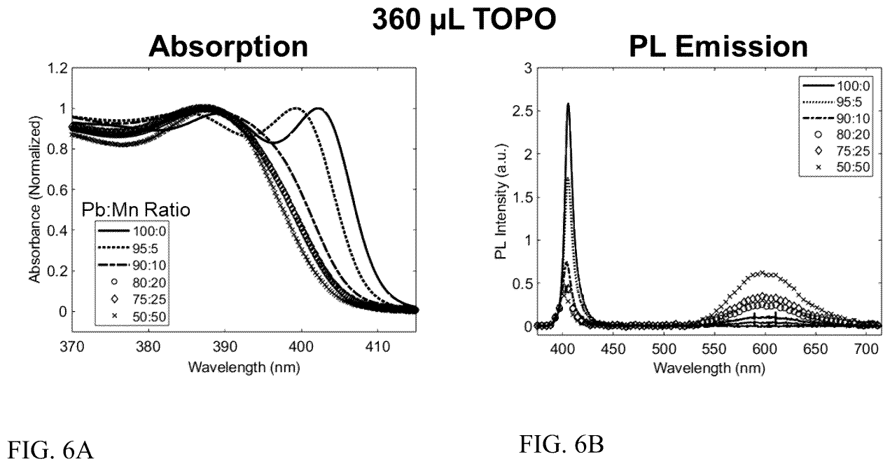

FIG. 8A-8D illustrate the excitation dynamics of doped nanocrystals as a function of quantum confinement. (A) Transient absorption (TA) spectra of 5.5 nm CsPbCl₃ NCs at various pump-probe delay times. (B) Normalized TA bleach kinetics of 1.8 atom-% Mn-doped CsPbCl₃ NCs for different sizes. No size dependence of the kinetics for doped samples is observed. All TA experiments were performed at a pump wavelength of 343 nm (ca. 100 fs pulses) with an excitation fluence of 3 μJ/cm2. (C) Normalized TA kinetics probed at the respective ground-state bleach for CsPbCl₃ NCs of different sizes. Faster recombination is observed for larger NCs. (D) Schematic describing the electron density (shaded area) in a Mn-doped CsPbCl₃ lattice and showing charge localization around the dopant.

FIG. 9A-9B illustrate the generalization to other metals (Zn and Ni) of the method of preparing a composition comprising metal-doped halide perovskite nanocrystals, which is in fact a doping method of halide perovskite nanocrystals with metallic element. (A) Normalized absorption spectra of Ni-doped CsPbCl₃ nanocrystals. (B) Normalized absorption spectra of Zn-doped CsPbCl₃ nanocrystals. In both situations, two different NC sizes are shown as a function of the respective dopant concentration, resulting in the expected dopant-induced blue-shift due to lattice periodicity breaking for unchanged NC sizes and halide composition.

FIG. 10A-10B show time-resolved emission spectra of CsPbCl₃ NCs (A) with an edge length of about 5 nm with varying levels of Mn doping and (B) with an edge length of about 9 nm with varying levels of Mn doping.

FIG. 11 shows time-resolved emission spectra of undoped CsPbCl₃ NCs with an edge length of about 6.5 nm (gray circles) and Mn-doped CsPbCl₃ NCs with varying Mn content.

FIG. 12 shows time-resolved emission spectra of undoped CsPbBr₃ nanocrystal with an edge length of about 6.5 nm (gray circles) and Mn-doped CsPbX₃ nanocrystal with a doping ratio Pb:Mn of 75:25 (in B-site stock solution).

FIG. 13 shows graphs of exciton ground state bleach kinetics, probed at their relevant maxima, for undoped (gray circles) and Mn-doped (black X) CsPbCl₃ nanocrystals with a size corresponding to the edge length of 5.5 nm.

FIG. 14 shows graphs of exciton ground state bleach kinetics, probed at their relevant maxima, for undoped (gray circles) and Mn-doped (black X) CsPbCl₃ nanocrystals with a size corresponding to the edge length of 10 nm.

FIG. 15A-15B show graphs of (A) exciton ground state bleach kinetics, probed at their relevant maxima, for undoped CsPbCl₃ nanocrystals of various sizes and of (B) exciton ground state bleach kinetics, probed at their relevant maxima, for Mn-doped CsPbCl₃ nanocrystals of various sizes with a doping ration Pb²⁺:Mn of 50:50.

### DETAILED DESCRIPTION OF THE INVENTION

Interesting magneto-optical properties have been observed in other semiconductor nanocrystal systems (e.g., ZnSc or CdSc quantum dots) doped with Mn, but only when the nanocrystals are very small (quantum confined), e.g., from about 3 to about 7 nm edge length in halide perovskite nanocrystals (HP NCs). Smaller, more quantum confined perovskite nanocrystals doped with Mn could be crucial for the control of electron spin, useful for spintronics.

Typical Mn-doped perovskite nanocrystals are too large to see unique magneto-optical effects that are observed in other nanocrystal material classes, due to the synthetic limitations imposed by traditional “hot synthesis” methods. Taking the widely studied CsPbBr₃ as an example, undoped CsPbBr₃ NCs are formed upon the injection of Cs-oleate into a PbBr₂ precursor containing oleylamine and oleic acid ligands. In this case, the reaction occurs to completion within seconds, meaning that NC nucleation and growth processes cannot be significantly separated temporally. Therefore, only temperature can be used as a handle to modify NC size using hot injection approaches, and narrow size dispersions are difficult to obtain without post-synthetic separation methods.

Recently, a new synthesis approach of HP NCs has been achieved using a complexation agent or complexing agent, trioctylphosphine oxide (TOPO) to weakly bind to the reaction precursors, i.e. the mixture of halide salts PbBr₂ and Cs₂CO₃, resulting in a slower reaction that yielded monodisperse HP NCs, whose size is tunable from 3 to 13 nm in edge length. Importantly, this synthetic approach can occur at room temperature, and contains multiple convenient handles to control the NC size, and therefore quantum confinement. In short, this NC synthesis route occurs according to the equilibrium shown in eq II. Cs⁺ cations are introduced into the reaction mixture in the form of a Cs-diisooctylphosphinate (DOPA) complex, which reacts with the PbBr₂-TOPO complex to form a Cs⁺/haloplumbate PbBr₃⁻ intermediate ion pair. This Cs[PbBr₃] serves as a monomer species, resulting in the formation and subsequent growth of CsPbBr₃ NCs. All perovskite NCs produced by this synthetic approach are undoped HP NCs.

$$3 P b B {r}_{2} [ T O P O ] + 2 CsDOPA ⇋ 2 C s [ P b B {r}_{3} ] + P {b ( DOPA )}_{2} + T O P O \qquad ( II )$$

As this reaction mechanism occurs in the order of minutes rather than seconds, size can be controlled temporally, in contrast to hot injection methods. Further, as guided by the reaction equilibrium, the concentration of TOPO in the solution is a convenient handle to control the size of the resultant CsPbBr₃ NCs, as a higher TOPO concentration shifts the equilibrium balance toward the reactants, as it limits the formation of Cs[PbBr₃] monomer species, resulting in larger NCs being formed.

While this method is successful in synthesizing pristine, undoped HP NCs, there is currently a large, outstanding gap of work where small size pure doped HP NCs can be successfully synthesized. Despite the appealing optical properties of HP NCs as described previously, HP NCs face issues due to their low stability in ambient conditions. Strongly confined HP NCs cannot be synthesized by simply lowering the temperature; mixtures of cubic NCs and nanoplatelets can be observed. Confined undoped NCs have been reported and obtained either directly through precursors modification or through post-synthetic purification processes. Doping or alloying the B-site cation in HP NCs could also help to mediate this issue, as the stability could be increased due to more favorable lattice parameters. Further, the doping of semiconductor HP NCs can modulate the electronic, optical, and magnetic properties of the resultant NCs. Mn²⁺ is commonly the workhorse dopant in semiconductor NCs, due in part to its five unpaired d-electrons, which can impart interesting magneto-optical properties in confined HP NCs, most notably in II-VI HP NCs. Beyond these magneto-optical effects, Mn-doped HP NCs feature emission from a Mn²⁺ spin-forbidden transition (⁴T₁→⁶A₁) upon energy transfer from the host NC. Interestingly, despite the additional decay pathway of Mn emission in Mn-doped CsPbCl₃ NCs, the PL QY of the HP band-edge emission increased upon Mn-doping. This phenomenon has been recently explained by dopant-induced charge carrier localization effects, which concomitantly enhances the radiative recombination rate, potentially paving the way for more efficient blue-emitting LEDs.

However, there is no generalizable synthesis method of doped HP NCs that allows for the same size control and NC monodispersity as their undoped counterparts. Thus, dopant effects on the electronic properties of the host NC cannot be disentangled from quantum confinement effects.

The methods and compositions of the present disclosure meet the existing need in synthesizing small, size pure doped HP NCs, since the methods of the present disclosure result in size-tunable HP NCs doped with highly controlled dopant concentrations of various metals, working under ambient conditions at room temperature. The methods of the present disclosure are simple, scalable, and may be performed at room temperature.

### Methods of Preparing Crystalline Halide Perovskite Particles

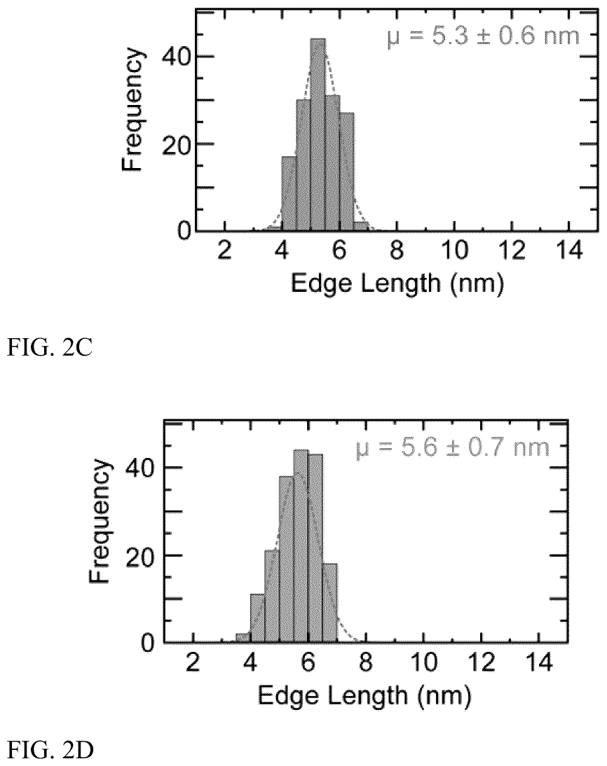

In particular embodiments, the methods provide herein can dope HP NCs from 5-10 nm in size, i.e. edge length with Mn, Ni, and Zn. This is notable, as interesting magneto-optical properties of Mn-doped NCs have only been able to be “unlocked” in very small, quantum confined nanocrystals. In certain embodiments, MnCl₂ is added to the reaction mixture, resulting in Mn-doped HP NCs with varied halide content, depending on the ratio of PbBr₂ to MnCl₂ in the precursor solution or the B-site stock solution. In certain such embodiments, the final halide composition of the Mn-doped HP NCs synthesized using this synthetic approach may be adjusted with a halide exchange reagent. In some embodiments, this is done by adding 1 mL of a 10 mg/mL oleylammonium chloride solution, resulting in CsPbₓMn₁₋ₓCl₃ NCs being a particular second halide perovskite of the present disclosure having, at each occurrence, a halide X selected from Cl, said particular second halide perovskite being doped by Mn. According to existing methods, ZnCl₂ is used to exchange halide in CsPbBr₃ HP NCs. However, divalent metal salts used as halide exchange agents are known for uncontrolled cation exchange in B-site of non-doped HP NCs. To avoid displacing Pb or other divalent dopants present in doped HP NCs, organic cations paired with halide or large metal salts with higher valencies are preferably used as halide exchange reagents in the methods of this disclosure. FIG. 4 shows a schematic overview of an exemplary method of the disclosure to produce exemplary nanocrystalline CsPbCl₃ doped with Mn (HP NC=halide perovskite nanocrystal; TOPO=trioctylphosphine oxide; OlAmCl=oleylammonium chloride).

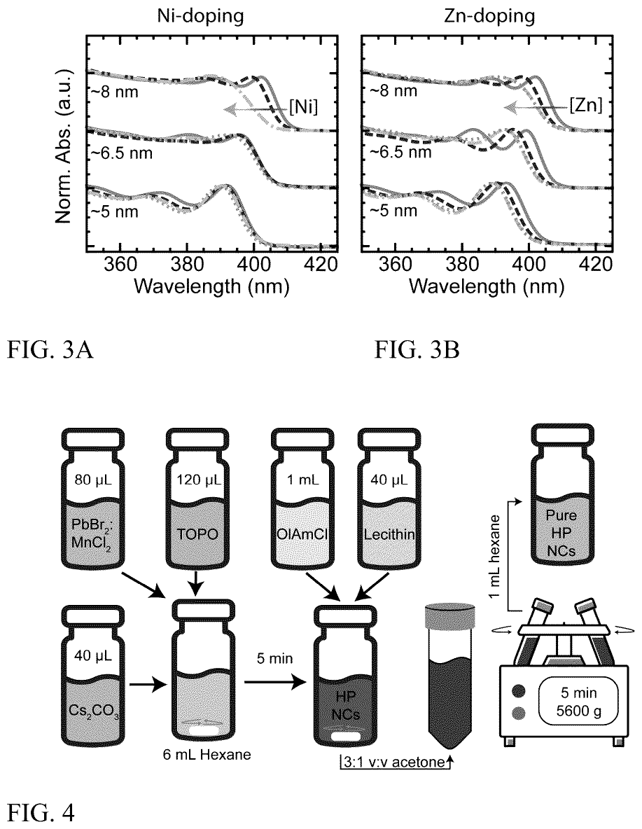

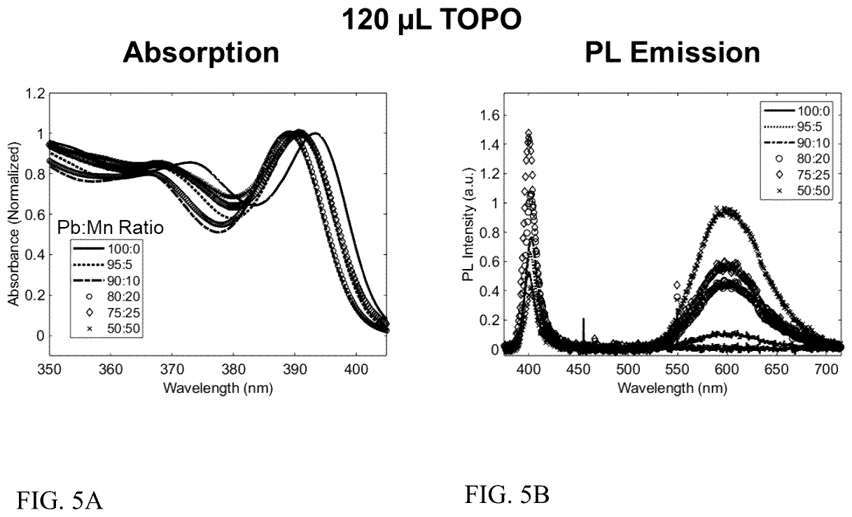

The absorption and photoluminescence (PL) emission of differently sized NCs, doped with various amounts of Mn were measured, where the absorption and emission both redshift with increasing size, in accordance with the quantum confinement effect. The blueshift of absorption and emission is evidence of Mn incorporation, along with a strong spin-forbidden Mn emission, centered at 600 nm as illustrated in FIGS. 5A-5B, 6A-6B.

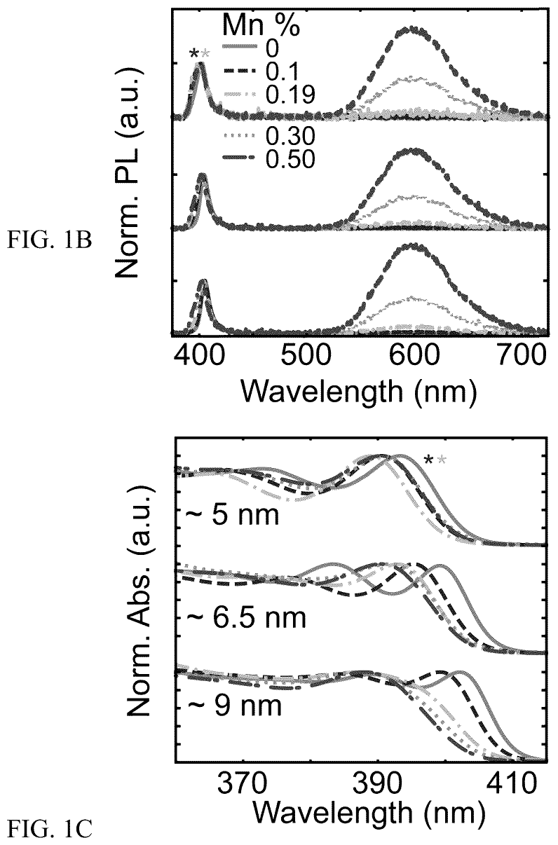

Further, using transmission electron microscopy (TEM), it was determined that the size corresponding to the edge length of the HP NCs does not change significantly upon Mn-doping, even in the smaller NCs. Representative pristine and Mn-doped CsPbCl₃ NCs are shown in the TEM micrographs in FIGS. 2A and 2B, respectively, and the histograms in FIGS. 2C and 2D show the edge lengths of multiple nanocrystals, respectively. These results have been reproduced in doped nanocrystals with edge lengths from about 5 to about 10 nm. Several edge lengths were measured from the TEM images using ImageJ program and a mean of said edge length is calculated. The sizes of the HP NCs herein correspond in fact to the edge length mean for a specific doped HP NC, unless d(0.9) for a particular HP NCs.

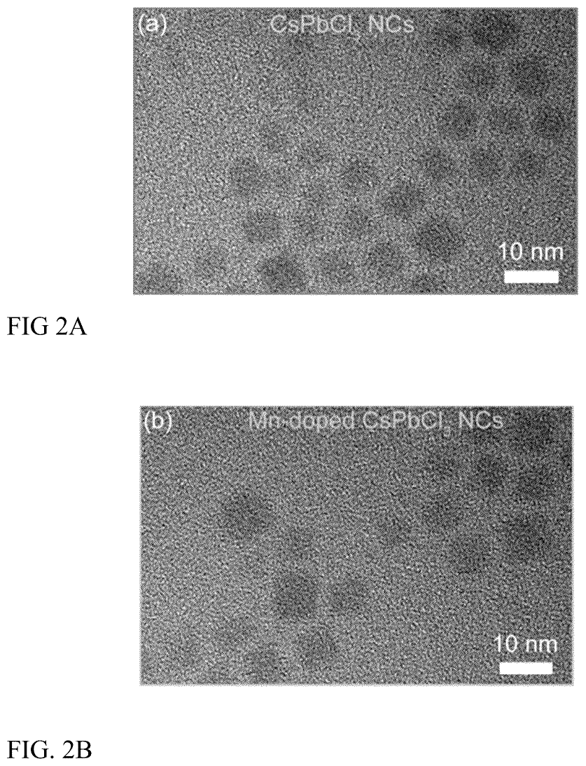

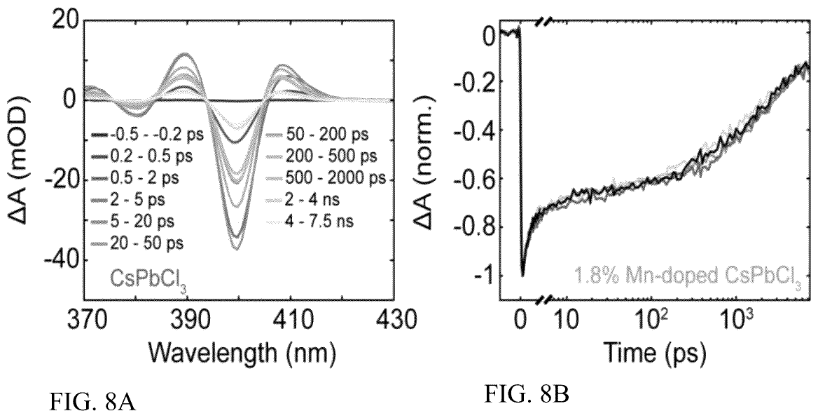

Additionally, the doping approaches provided herein can be generalized to used other metal as dopants. For example, Zn and Ni were successfully used as dopants in the methods described herein to dope HP NCs. Upon the addition of Zn and Ni into the HP NCs, characteristic blue shifting of the perovskite excitonic absorption is observed such as illustrated in FIGS. 3A-3B and 9A-.

In certain embodiments, a complexing agent selected from a molecule comprising at least one non-polar hydrocarbyl group and at least one polar group is added to the combination of the A-site stock solution with the B-site stock solution. Said complexing agent may be selected from the group consisting of long-chain alkylsulfobetaines, phosphocholines, phospholipids, long-chain alkylamines, and long-chain alkylacids. In some embodiments, said complexing agent is selected from trioctylphosphine oxide (TOPO), diisooctylphosphinate (DOPA), oleylamine (OAm), and oleic acid (OA). In preferred embodiments, the complexing agent is a B-site complexing agent. The complexing agent is selected from trioctylphosphine oxide (TOPO).

In certain embodiments, methods of the disclosure further comprise:
contacting the first product mixture with a halide exchange solution;
   wherein the halide exchange solution comprises:
      a halide exchange reagent, the halide exchange reagent comprising an additional halide; and
      a fourth non-polar solvent;
under conditions suitable to exchange at least one halide ion of the first halide perovskite with the additional halide;
thereby forming a second product mixture comprising crystalline particles of a second halide perovskite, wherein the second halide perovskite has a chemical formula according to Formula (I), and further wherein each X is the same.

In some embodiments, the halide exchange reagent is selected from a halide salt. The halide salt is selected from an inorganic halide and an organic halide. The halide salt for the halide exchange solution is selected to have the same halide at each occurrence of X. In certain embodiments, the halide exchange reagent is an oleylammonium halide and WCl₆ or a combination thereof, when halide is Cl. In certain preferred embodiments, the halide exchange reagent is selected from oleylammonium chloride, oleylammonium bromide, oleylammonium iodide, and WCl₆.

In certain embodiments, each occurrence of X is Cl, Br or I after submitting the first halide perovskite of the disclosure to the step of the halide exchange. In some preferred embodiments, each occurrence of X is Br or Cl. In certain embodiments, each occurrence of X is I.

In certain embodiments, the second product mixture comprises the A-site complexing agent, the B-site complexing agent, and the second halide perovskite; and the method further comprises:
contacting the second product mixture with a ligand exchange solution, the ligand exchange solution comprising:
   at least one ligand; and
   a fifth non-polar solvent;
under conditions suitable to exchange the A-site complexing agent and/or the B-site complexing agent with the at least one ligand, thereby forming a third product mixture comprising ligated crystalline particles of the second halide perovskite;
wherein the ligated crystalline particles each have an outer surface, and each of the ligated crystalline particles further comprises at least one ligand bonded to the outer surface of the ligated crystalline particle.

In some embodiments, the A-site complexing agent and the B-site complexing agent are each, independently, selected from a molecule comprising at least one non-polar hydrocarbyl group and at least one polar group. Said A-site and/or B-site complexing agents are selected from chemical compounds enabling the formation of complexes with the cation and/or the anion of the A and/or B elements in the synthesis methods of the disclosure. the A-site complexing agent and the B-site complexing agent are each, independently, selected from coordinating agent a compound having at least one non-polar hydrocarbyl group and at least one polar group. In certain embodiments, the A-site complexing agents and B-site complexing agents are independently selected from trioctylphosphine oxide (TOPO), diisooctylphosphinate (DOPA), oleylamine (OAm), and oleic acid (OA). They may bind to the outer surface of the crystalline particles in the first and/or second product mixture, wherein the halide is or is not exchanged. They may also be present on the outer surface to the crystalline particles of the third product mixture and/or they may be partially exchanged for at least one ligand. They are present on the outer surface of the crystalline particles of the product mixture before to be exchanged by a ligand being a compound having at least one non-polar hydrocarbyl group and at least one zwitterionic group.

In certain embodiments, the method further comprises isolating the ligated crystalline particles from the third product mixture.

In some embodiments, the at least one ligand is a molecule comprising at least one non-polar hydrocarbyl group and at least one zwitterionic group.

In certain embodiments, the at least one ligand is selected from the group consisting of long chain sulfobetaines, phosphocholines, phospholipids, long-chain alkylamines, and long-chain alkylacids. In certain preferred embodiments, the at least one ligand is lecithin.

In some embodiments, the first non-polar solvent, second non-polar solvent, third non-polar solvent, fourth non-polar solvent, and fifth non-polar solvent are each independently selected from a C₅-C₁₀ hydrocarbon, or is a mixture thereof. In certain preferred embodiments, the first non-polar solvent, second non-polar solvent, third non-polar solvent, fourth non-polar solvent, and fifth non-polar solvent are each independently selected from pentanes, petroleum ether, hexanes, heptanes, octanes, toluene, and xylene, or a mixture thereof.

In certain embodiments, each of the first non-polar solvent, second non-polar solvent, third non-polar solvent, fourth non-polar solvent, and fifth non-polar solvent are the same.

In some embodiments, each of the first non-polar solvent, second non-polar solvent, third non-polar solvent, fourth non-polar solvent, and fifth non-polar solvent are different.

### Compositions Comprising Crystalline Particles of a Halide Perovskite

In certain embodiments, provided herein are compositions, comprising crystalline particles of a halide perovskite, the halide perovskite having a chemical formula according to Formula I:

ABX₃ (I);
wherein:
   A is a monocation;
   B is selected from Pb²⁺, a dopant and a combination thereof;
   X, independently at each occurrence, is a halide;
wherein the dopant is a dication or trication of a metallic element; and
further wherein the crystalline particles have an edge length distribution characterized by a d(0.9) of less than about 8.5 nm.

d(0.9) corresponds to a point along a distribution curve of the NCs sizes that fall below 90%. For example, d(0.9) of less than about 8.5 nm is defined as the point on a distribution curve of the measured edge lengths of the HP NCs on TEM images which 90% of the particles have an edge length of less than about 8.5 nm.

In another aspect, the invention provides a composition comprising ligated crystalline particles of a halide perovskite obtained according to the methods of the disclosure and having an edge length of less than about 9 nm. In some embodiments, the edge length of the crystalline particles is in the range from about 2 nm to about 10 nm, preferably from about 3 nm to 9 nm.

As will be appreciated by one of ordinary skill in the art, the identities of A, B, and X, are defined in part by size limitations of the perovskite structure. For example, halide perovskites, i.e. metal doped HP NCs, described herein may have a Goldschmidt tolerance factor (t) of about 1 as calculated by formula (III):

$$t = \frac{{r}_{A} + {r}_{B}}{\sqrt{2 (} {r}_{A} + {r}_{X} )} \qquad ( III )$$

wherein r_{A} is the ionic radius of A, r_{B} is the atomic radius of B, and r_{X} is the atomic radius of X. Accordingly, suitable combinations of A, B, and X, as defined herein, will be apparent to one of skill in the art upon reading this disclosure.

In certain embodiments, A is a monocation of a metallic element or a monocationic organic group. In some embodiments, A is a monocation of a metallic element selected from Group 1 of the periodic table. In further embodiments, A is selected from Li⁺, Na⁺, K⁺, Rb⁺, and Cs⁺. In certain preferred embodiments, A is Cs⁺.

In some embodiments, A is a monocationic organic group. In certain such embodiments, A is selected from methylammonium [(CH₃NH₃)⁺], formamidinium [(HC(NH₂)₂⁺], ethylammonium [(H₅C₂NH₃)⁺], butylammonium [(H₉C₄NH₃)⁺], and guanidinium [C(NH₂)₃⁺]. In certain preferred embodiments, A is methylammonium [(CH₃NH₃)⁺] or formamidinium [(HC(NH₂)₂⁺].

In certain embodiments, the dopant is a dication of a metallic element. In further embodiments, the dopant is a dication of a metallic element selected from Group 2, Group 3, Group 7, Group 8, Group 9, Group 10, Group 12, and Group 14 of the periodic table. In yet further embodiments, the dopant is selected from Sn²⁺, Cd²⁺, Zn²⁺, Mn²⁺, Sr²⁺, Ni²⁺, Fe²⁺, Mn²⁺, Zn²⁺, Ni²⁺, Sr²⁺, Ca²⁺, Sm²⁺, Eu²⁺, and Co²⁺. In certain preferred embodiments, the dopant is Mn²⁺. In other preferred embodiments, the dopant is Zn²⁺. In some preferred embodiments, the dopant is Ni²⁺.

In certain embodiments, the dopant is a trication of a metallic element. In further embodiments, the dopant is a trication of a metallic element selected from Group 2, Group 3, Group 8, Group 9, Group 13, and Group 15. In yet further embodiments, the dopant is selected from Eu³⁺, Bi³⁺, In³⁺, Yb³⁺, Ce³⁺, Er³⁺, Sm³⁺, Eu³⁺, Th³⁺, and Dy³⁺.

In certain embodiments, the halide perovskite comprises the dopant in an atomic ratio of from about 1:10000 to about 1:100 relative to Pb²⁺. In example embodiments, the halide perovskite comprises the dopant in an atomic ratio of about 1:10000, about 2:10000, about 3:10000, about 4:10000, about 5:10000, about 6:10000, about 7:10000, about 8:10000, about 9:10000, or about 1:1000. In other example embodiments, the halide perovskite comprises the dopant in an atomic ratio of about 1:1000, about 2:1000, about 3:1000, about 4:1000, about 5:1000, about 6:1000, about 7:1000, about 8:1000, about 9:1000, or about 1:100.

In certain embodiments, the edge length distribution is characterized by a d(0.9) of about 5.5 nm to about 8 nm. In some embodiments, the edge length distribution is characterized by a d(0.9) of about 8 nm. In certain embodiments, the edge length distribution is characterized by a d(0.9) of about 7.5 nm. In some embodiments, the edge length distribution is characterized by a d(0.9) of about 6.5 nm. In certain preferred embodiments, the edge length distribution is characterized by a d(0.9) of about 6 nm.

In certain embodiments, the crystalline particles each has an outer surface, at least one crystalline particle further comprises at least one ligand bonded to the outer surface of the at least one crystalline particle. In further embodiments, the at least one ligand is a molecule comprising at least one non-polar hydrocarbyl group and at least one polar group. In yet further embodiments, the at least one ligand is selected from the group consisting of long-chain alkylsulfobetaines, phosphocholines, phospholipids, long-chain alkylamines, and long-chain alkylacids. In some embodiments, the at least one ligand is selected from trioctylphosphine oxide (TOPO), lecithin, oleylamine (OAm), and oleic acid (OA). In preferred embodiments, the at least one ligand is lecithin.

Metal doped HP NCs of this disclosure are promising materials for optoelectronic applications. Metal doping improves the performance of such crystalline particles of the disclosure, e.g., by enhancing light emission, or to provide additional functionalities, such as nanoscale magnetism and polarization control.

In a further aspect, the invention proposes a perovskite-based device comprising ligated crystalline particles of a halide perovskite obtained according to the methods of the disclosures and being selected from an optoelectronic device, a photoelectrochemical device, a sensor, a nanoscale magnet and a quantum material-based spintronic device.

In certain embodiments, the perovskite-based device comprises the ligated crystalline particles of a halide perovskite having an edge length of less than about 9 nm.

The disclosure provides a generalizable synthesis method for metal-doped halide perovskite NCs, which enables full size- and composition tunability, which is scalable and operates under ambient conditions at room temperature. This method allows the incorporation of metal dopants into the lattice during synthesis, and for unprecedented synthetic control across multiple NC sizes and dopant level regimes. This synthetic method for doping HP NCs will provide additional leverage to further shift the bandgap while maintaining stability. Importantly, controlled metal doping can also enable new functionalities, such as magnetic exchange interactions in the case of magnetic dopants, for unexplored applications in spin-photonic interfaces and quantum information processing, or improving device performance in the deep blue to UV spectral range for the technical fields of light-emitting diodes (LEDs) and water disinfection.

### Definitions

Unless otherwise defined herein, scientific and technical terms used in this application shall have the meanings that are commonly understood by those of ordinary skill in the art. Generally, nomenclature used in connection with, and techniques of, chemistry, cell and tissue culture, molecular biology, cell and cancer biology, neurobiology, neurochemistry, virology, immunology, microbiology, pharmacology, genetics and protein and nucleic acid chemistry, described herein, are those well known and commonly used in the art.

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March, March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “aliphatic” refers to alkyl, alkenyl, alkynyl, and carbocyclic groups. Likewise, the term “heteroaliphatic” refers to heteroalkyl, heteroalkenyl, heteroalkynyl, and heterocyclic groups.

The term “hydrocarbyl” as used herein refers to an alkyl or alkenyl group.

The term “alkyl” as used herein refers to a radical of a straight-chain or branched saturated hydrocarbon group having from 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁-6 alkyl, e.g., —CF₃, Bn).

The term “polar group” as used herein refers to an organic functional group or molecule, which may be overall neutral or charged, and which carries a net dipole moment. As a non-limiting example, a polar group may refer to optionally substituted groups selected from: phosphate, phosphate diester, amine, ammonium, alkoxy, carboxylate, aldehyde, or a zwitterionic group (a functional group comprising a positively charged site and a negatively charged site) comprising, e.g., a positively charged ammonium group and a negatively charged phosphate or carboxylate group. Non-limiting examples of molecules comprising polar groups include trioctylphosphine oxide (TOPO), diisooctylphosphinate (DOPA), lecithin, oleylamine (OAm), and oleic acid (OA).

The term “hydroxyalkyl” is a substituted alkyl group, wherein one or more of the hydrogen atoms are independently replaced by a hydroxyl. In some embodiments, the hydroxyalkyl moiety has 1 to 8 carbon atoms (“C₁₋₈ hydroxyalkyl”). In some embodiments, the hydroxyalkyl moiety has 1 to 6 carbon atoms (“C₁₋₆ hydroxyalkyl”). In some embodiments, the hydroxyalkyl moiety has 1 to 4 carbon atoms (“C₁₋₄ hydroxyalkyl”). In some embodiments, the hydroxyalkyl moiety has 1 to 3 carbon atoms (“C₁₋₃ hydroxyalkyl”). In some embodiments, the hydroxyalkyl moiety has 1 to 2 carbon atoms (“C₁₋₂ hydroxyalkyl”).

The term “alkoxy” refers to an alkyl group, as defined herein, appended to the parent molecular moiety through an oxygen atom. In some embodiments, the alkoxy moiety has 1 to 8 carbon atoms (“C₁₋₈ alkoxy”). In some embodiments, the alkoxy moiety has 1 to 6 carbon atoms (“C₁₋₆ alkoxy”). In some embodiments, the alkoxy moiety has 1 to 4 carbon atoms (“C₁₋₄ alkoxy”). In some embodiments, the alkoxy moiety has 1 to 3 carbon atoms (“C₁₋₃ alkoxy”). In some embodiments, the alkoxy moiety has 1 to 2 carbon atoms (“C₁₋₂ alkoxy”). Representative examples of alkoxy include, but are not limited to, methoxy, ethoxy, propoxy, 2-propoxy, butoxy and tert-butoxy.

The term “alkoxyalkyl” is a substituted alkyl group, wherein one or more of the hydrogen atoms are independently replaced by an alkoxy group, as defined herein. In some embodiments, the alkoxyalkyl moiety has 1 to 8 carbon atoms (“C₁₋₈ alkoxyalkyl”). In some embodiments, the alkoxyalkyl moiety has 1 to 6 carbon atoms (“C₁₋₆ alkoxyalkyl”). In some embodiments, the alkoxyalkyl moiety has 1 to 4 carbon atoms (“C₁₋₄ alkoxyalkyl”). In some embodiments, the alkoxyalkyl moiety has 1 to 3 carbon atoms (“C₁₋₃ alkoxyalkyl”). In some embodiments, the alkoxyalkyl moiety has 1 to 2 carbon atoms (“C₁₋₂ alkoxyalkyl”).

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkyl group refers to a saturated group having from 1 to 20 carbon atoms and 1 or more heteroatoms within the parent chain (“heteroC₁₋₂₀ alkyl”). In some embodiments, a heteroalkyl group is a saturated group having 1 to 18 carbon atoms and 1 or more heteroatoms within the parent chain (“heteroC₁₋₁₈ alkyl”). In some embodiments, a heteroalkyl group is a saturated group having 1 to 16 carbon atoms and 1 or more heteroatoms within the parent chain (“heteroC₁₋₁₆ alkyl”). In some embodiments, a heteroalkyl group is a saturated group having 1 to 14 carbon atoms and 1 or more heteroatoms within the parent chain (“heteroC₁₋₁₄ alkyl”). In some embodiments, a heteroalkyl group is a saturated group having 1 to 12 carbon atoms and 1 or more heteroatoms within the parent chain (“heteroC₁₋₁₂ alkyl”). In some embodiments, a heteroalkyl group is a saturated group having 1 to 10 carbon atoms and 1 or more heteroatoms within the parent chain (“heteroC₁₋₁₀ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1 to 2 carbon atoms and 1 heteroatom within the parent chain (“heteroC₁₋₂ alkyl”). In some embodiments, a heteroalkyl group is a saturated group having 1 carbon atom and 1 heteroatom (“heteroC₁ alkyl”). In some embodiments, the heteroalkyl group defined herein is a partially unsaturated group having 1 or more heteroatoms within the parent chain and at least one unsaturated carbon, such as a carbonyl group. For example, a heteroalkyl group may comprise an amide or ester functionality in its parent chain such that one or more carbon atoms are unsaturated carbonyl groups. Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₂₀ alkyl. In certain embodiments, the heteroalkyl group is an unsubstituted heteroC₁₋₁₀ alkyl. In certain embodiments, the heteroalkyl group is a substituted heteroC₁₋₂₀ alkyl. In certain embodiments, the heteroalkyl group is an unsubstituted heteroC₁₋₁₀ alkyl.

The term “alkenyl” refers to a radical of a straight-chain or branched hydrocarbon group having from 2 to 10 carbon atoms and one or more carbon-carbon double bonds (e.g., 1, 2, 3, or 4 double bonds). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl. In an alkenyl group, a C═C double bond for which the stereochemistry is not specified

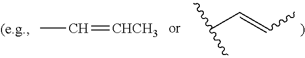

may be an (E)- or (Z)-double bond.

The term “heteroalkenyl” refers to an alkenyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”).

In some embodiments, a heteroalkenyl group has 2 to 8 carbon atoms, at least one double bond, and 1 or more heteroatoms within the parent chain (“heteroC₂₋₈ alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂₋₅ alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

The term “alkynyl” refers to a radical of a straight-chain or branched hydrocarbon group having from 2 to 10 carbon atoms and one or more carbon-carbon triple bonds (e.g., 1, 2, 3, or 4 triple bonds) (“C2_10 alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C_{2_4} alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂₋₈ alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”). In some embodiments, a heteroalkynyl group has 2 to 4 carbon atoms, at least one triple bond, and 1 or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

The term “unsaturated bond” refers to a double or triple bond.

The term “unsaturated” or “partially unsaturated” refers to a moiety that includes at least one double or triple bond.

The term “saturated” refers to a moiety that does not contain a double or triple bond, i.e., the moiety only contains single bonds.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

A group is optionally substituted unless expressly provided otherwise. The term “optionally substituted” refers to being substituted or unsubstituted. In certain embodiments, alkyl, alkenyl, alkynyl, heteroalkyl, heteroalkenyl, heteroalkynyl, carbocyclyl, heterocyclyl, aryl, and heteroaryl groups are optionally substituted. “Optionally substituted” refers to a group which may be substituted or unsubstituted (e.g., “substituted” or “unsubstituted” alkyl, “substituted” or “unsubstituted” alkenyl, “substituted” or “unsubstituted” alkynyl, “substituted” or “unsubstituted” heteroalkyl, “substituted” or “unsubstituted” heteroalkenyl, “substituted” or “unsubstituted” heteroalkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not intended to be limited in any manner by the exemplary substituents described herein.

Exemplary carbon atom substituents include, but are not limited to, halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR)R^{bb}, —SH, —SR^{aa}, —SSR^{cc}, —C(═O)R^{aa}, —CO₂H, —CHO, —C(OR)₃, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSOR^{aa}, —S(═O)R^{aa}, —OS(═O)R^{aa}, —Si(R^{aa})₃, —OSi(R^{aa})₃, —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{cc})₂, —P(═O)(N(R^{bb})₂)₂, —OP(═O)(N(R^{bb})₂)₂, NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃⁺X⁻, —P(OR^{cc})₃⁺X⁻, —P(R^{cc})₄, —P(OR^{cc})₂, —OP(R)₂, —OP(R^{cc})₃⁺X⁻, —OP(OR^{cc})₂, —OP(OR^{cc})₃⁺X⁻, —OP(R^{cc})₄, —OP(OR^{cc})₄, —B(R^{aa})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X is a counterion; or two geminal hydrogens on a carbon atom are replaced with the group ═O, ═S, ═NN(R^{bb})₂, ═NNR^{bb}C(═O)R^{aa}, ═NNR^{bb}C(═O)OR^{aa}, ═NNR^{bb}S(═O)₂R^{aa}, ═NR^{bb} or ═NOR^{cc}; each instance of R^{aa} is, independently, selected from C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{bb} is, independently, selected from hydrogen, —OH, —OR^{aa}, —N(R)₂, —CN, —C(═O)R^{aa}, —C(═O)N(R)₂, —CO₂R^{aa}, —SO₂R^{aa}, —C(═NR^{cc})OR^{aa}, —C(═NR^{cc})N(R)₂, —SO₂N(R)₂, —SO₂R^{aa}, —SO₂OR^{cc}, —SOR^{aa}, —C(═S)N(R)₂, —C(═O)SR^{cc}, —C(═S)SR^{cc}, —P(═O)(R^{aa})₂, —P(═O)(OR^{cc})₂, —P(═O)(N(R)₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X is a counterion; each instance of R^{cc} is, independently, selected from hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two Rec groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR)R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(—O)(R^{ee})₂, —OP(═O)(R^{ee})₂,

—OP(═O)(OR^{ee})₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S; wherein X is a counterion; each instance of R^{ee} is, independently, selected from C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; each instance of R^{ff} is, independently, selected from hydrogen, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl and 5-10 membered heteroaryl, or two R^{ff} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)₂⁺X⁻, —NH₂(C₁₋₆ alkyl)₃⁺X⁻, —NH₃⁺X⁻, —N(OC₁₋₆ alkyl) (C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(═NH)NH(C₁₋₆ alkyl), —OC(═NH)NH₂, —NHC(═NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂(C₁₋₆ alkyl), —SO₂O(C₁₋₆ alkyl), —OSO₂(C₁₋₆ alkyl), —SO(C₁₋₆ alkyl), —Si(C₁₋₆ alkyl)₃, —OSi(C₁₋₆ alkyl)₃, —C(═S)N(C₁₋₆ alkyl)₂, —C(═S)NH(C₁₋₆ alkyl), —C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, 5-10 membered heteroaryl; or two geminal R^{gg} substituents can be joined to form ═O or ═S; wherein X is a counterion.

The term “halo” or “halogen” refers to fluorine (fluoro, —F), chlorine (chloro, —Cl), bromine (bromo, —Br), or iodine (iodo, —I).

The term “hydroxyl” or “hydroxy” refers to the group-OH. The term “substituted hydroxyl” or “substituted hydroxyl,” by extension, refers to a hydroxyl group wherein the oxygen atom directly attached to the parent molecule is substituted with a group other than hydrogen, and includes groups selected from —OR^{aa}, —ON(R^{bb})₂, —OC(═O)SR^{aa}, —OC(═O)R^{aa}, —OCO₂R^{aa}, —OC(═O)N(R^{bb})₂, —OC(═NR^{bb})R^{aa}, —OC(═NR^{bb})OR^{aa}, —OC(═NR^{bb})N(R^{bb})₂, —OS(═O)R^{aa}, —OSO₂R^{aa}, —OSi(R^{aa})₃, —OP(R^{cc})₂, —OP(R^{cc})₃⁺X⁻, —OP(OR^{cc})₂, —OP(OR^{cc})₃⁺X⁻, —OP(═O)(R^{aa})₂, —OP(═O)(OR^{cc})₂, and —OP(═O)(N(R^{bb})₂)₂, wherein X, R^{aa}, R^{bb} and Rec are as defined herein.

The term “amino” refers to the group —NH₂. The term “substituted amino,” by extension, refers to a monosubstituted amino, a disubstituted amino, or a trisubstituted amino. In certain embodiments, the “substituted amino” is a monosubstituted amino or a disubstituted amino group.

The term “monosubstituted amino” refers to an amino group wherein the nitrogen atom directly attached to the parent molecule is substituted with one hydrogen and one group other than hydrogen, and includes groups selected from —NH(R^{bb}), —NHC(═O)R^{aa}, —NHCO₂R^{aa}, —NHC(═O)N(R^{bb})₂, —NHC(═NR^{bb})N(R^{bb})₂, —NHSO₂R^{aa}, —NHP(═O)(OR^{cc})₂, and —NHP(═O)(N(R^{bb})₂)₂, wherein R^{aa}, R^{bb}, and Rec are as defined herein, and wherein R^{bb} of the group —NH(R^{bb}) is not hydrogen.

The term “disubstituted amino” refers to an amino group wherein the nitrogen atom directly attached to the parent molecule is substituted with two groups other than hydrogen, and includes groups selected from —N(R^{bb})₂, —NR^{bb}C(═O)R^{aa}, —NR^{bb}CO₂R^{aa}, —NR^{bb}C(═O)N(R^{bb})₂, —NR^{bb}C(═NR^{bb})N(R^{bb})₂, —NR^{bb}SO₂R^{aa}, —NR^{bb}P(═O)(OR)₂, and —NR^{bb}P(═O)(N(R^{bb})₂)₂, wherein R^{aa}, R^{bb}, and Re are as defined herein, with the proviso that the nitrogen atom directly attached to the parent molecule is not substituted with hydrogen.

The term “trisubstituted amino” refers to an amino group wherein the nitrogen atom directly attached to the parent molecule is substituted with three groups, and includes groups selected from —N(R^{bb})₂ and —N(R^{bb})₃⁺X⁻, wherein R^{bb} and X are as defined herein.

The term “sulfonyl” refers to a group selected from —SO₂N(R^{bb})₂, —SO₂R^{aa}, and —SO₂OR^{aa}, wherein R^{aa} and R^{bb} are as defined herein.

The term “sulfinyl” refers to the group —S(═O)R^{aa}, wherein R^{aa} is as defined herein.

The term “acyl” refers to a group having the general formula —C(═O)R^{X1}, —C(═O)OR^{X1}, —C(═O)—O—C(═O)R^{X1}, —C(═O)SR^{X1}, —C(═O)N(R^{X1})₂, —C(═S)R^{X1}, —C(═S)N(R^{X1})₂, —C(═S)O(R^{X1}), —C(═S)S(R^{X1}), —C(═NR^{X1})R^{X1}, —C(═NR^{X1})OR^{X1}, —C(═NR^{X1}) SR^{X1}, and —C(═NR^{X1})N(R^{X1})₂, wherein R^{X1} is hydrogen; halogen; substituted or unsubstituted hydroxyl; substituted or unsubstituted thiol; substituted or unsubstituted amino; substituted or unsubstituted acyl, cyclic or acyclic, substituted or unsubstituted, branched or unbranched aliphatic; cyclic or acyclic, substituted or unsubstituted, branched or unbranched heteroaliphatic; cyclic or acyclic, substituted or unsubstituted, branched or unbranched alkyl; cyclic or acyclic, substituted or unsubstituted, branched or unbranched alkenyl; substituted or unsubstituted alkynyl; substituted or unsubstituted aryl, substituted or unsubstituted heteroaryl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, mono- or di-aliphaticamino, mono- or di-heteroaliphaticamino, mono- or di-alkylamino, mono- or di-heteroalkylamino, mono- or di-arylamino, or mono- or di-heteroarylamino; or two R^{X1} groups taken together form a 5- to 6-membered heterocyclic ring.

Exemplary acyl groups include aldehydes (—CHO), carboxylic acids (—CO₂H), ketones, acyl halides, esters, amides, imines, carbonates, carbamates, and ureas. Acyl substituents include, butare not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “carbonyl” refers a group wherein the carbon directly attached to the parent molecule is sp² hybridized, and is substituted with an oxygen, nitrogen or sulfur atom, e.g., a group selected from ketones (e.g., —C(═O)R^{aa}), carboxylic acids (e.g., —CO₂H), aldehydes (—CHO), esters (e.g., —CO₂R^{aa}, —C(═O)SR^{aa}, —C(═S)SR^{aa}), amides (e.g., —C(═O)N(R^{bb})₂, —C(═O)NR^{bb}SO₂R^{aa}, —C(═S)N(R^{bb})₂, and imines (e.g., —C(═NR^{bb})R^{aa}, —C(═NR^{bb})OR^{aa}), —C(═NR^{bb})N(R^{bb})₂, wherein R^{aa} and R^{bb} are as defined herein.

The term “oxo” refers to the group ═O, and the term “thiooxo” refers to the group ═S.

Nitrogen atoms can be substituted or unsubstituted as valency permits, and include primary, secondary, tertiary, and quaternary nitrogen atoms. Exemplary nitrogen atom substituents include, but are not limited to, hydrogen, —OH, —OR^{aa}, —N(R)₂, —CN, —C(═O)R^{aa}, —C(═O)N(R)₂, —CO₂R^{aa}, —SO₂R^{aa}, —C(═NR^{bb})R^{aa}, —C(═NR^{cc})OR^{aa}, —C(═NR)N(R)₂, —SO₂N(R)₂, —SO₂R^{cc}, —SO₂OR^{cc}, —SOR^{aa}, —C(═S)N(R)₂, —C(═O)SR^{cc}, —C(═S)SR^{cc}, —P(═O)(OR)₂, —P(═O)(R^{aa})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two Rec groups attached to an N atom are joined to form a 3-14 membered heterocyclyl or a 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, Roc and R^{dd} are as defined herein.

An “anionic counterion” is a negatively charged group associated with a positively charged group in order to maintain electronic neutrality. An anionic counterion may be monovalent (i.e., including one formal negative charge). An anionic counterion may also be multivalent (i.e., including more than one formal negative charge), such as divalent or trivalent. Exemplary counterions include halide ions (e.g., F⁻, Cl⁻, Br⁻, I⁻), NO₃⁻, ClO₄⁻, OH⁻, H₂PO₄⁻, HCO₃⁻, HSO₄⁻, sulfonate ions (e.g., methansulfonate, trifluoromethanesulfonate, p-toluenesulfonate, benzenesulfonate, 10-camphor sulfonate, naphthalene-2-sulfonate,

naphthalene-1-sulfonic acid-5-sulfonate, ethan-1-sulfonic acid-2-sulfonate, and the like), carboxylate ions (e.g., acetate, propanoate, benzoate, glycerate, lactate, tartrate, glycolate, gluconate, and the like), BF₄⁻, PF₄⁻, PF₆⁻, AsF₆⁻, SbF₆⁻, B[3,5-(CF₃)₂C₆H₃]₄⁻, B(C₆F₅)₄⁻, BPh₄, Al(OC(CF₃)₃)₄⁻, and carborane anions (e.g., CB₁₁H₁₂⁻ or (HCB₁₁Me₅Br₆)⁻). Exemplary counterions which may be multivalent include CO₃²⁻, HPO₄²⁻, PO₄³⁻, B₄O₇²⁻, SO₄²⁻, S₂O₃²⁻, carboxylate anions (e.g., tartrate, citrate, fumarate, maleate, malate, malonate, gluconate, succinate, glutarate, adipate, pimelate, suberate, azelate, sebacate, salicylate, phthalates, aspartate, glutamate, and the like), and carboranes.

The term “bonded” or “bound” as used herein refers to two species (e.g., a crystalline particle and a ligand, or a cation and an anion) that are interconnected via chemical bonds, the nature of which will be understood by one of ordinary skill the art. For example, chemical bonds involved in the compositions and methods of the present disclosure include but are not limited to dative bonds, covalent, bonds, ionic bonds, hydrogen bonds, and halogen bonds, which themselves are common terms of art and well understood by ordinarily skilled artisans thereof.

A “salt” as used herein refers to a compound comprising at least one positively charged ion (cation) and at least one negatively charged ion (anion), the compound itself being overall neutral in charge. As a non-limiting example, a salt may comprise: a metal monocation and a nonmetal anion (e.g., PbBr₂, MnCl₂, and CsCO₃); or a cation of an organic molecule and a nonmetal anion, e.g. formamidinium chloride, [CH(NH₂)₂]⁺Cl⁻.−.

The term “long-chain alkyl” as used herein refers to an alkyl group as defined above, having a carbon chain of at least about 5 carbons in length, e.g., from about 5 to about 25 carbons in length, or from about 8 to about 18 carbons in length. Long-chain alkyl groups may have one or more sites of unsaturation in the chain, e.g. one or more double bond. As a non-limiting example, long chain alkyl may refer to hexyl, heptyl, octyl, nonyl, stearyl, oleyl, and/or decyl groups. The term “long-chain alkyl” may be used to refer to lipids and vice versa.

The term “sulfobetaines” refers to functional groups or molecules comprising a positively charged quaternary ammonium and a negatively charged sulfonate group separated by a C3 alkyl group, or suitable salts thereof. A “long-chain sulfobetaine” is a molecule comprising a sulfobetaine group as defined above, and a long-chain alky group as defined above.

The term “phosphocholines” refers to functional groups or molecules having a quaternary ammonium group and a phosphate group separated by a C2 alkyl group, or suitable salts thereof. The phosphate group and/or the ammonium group may be substituted with one or more alkyl groups, e.g., a long-chain alkyl group as defined above. As a non-limiting example, lecithin may be referred to herein as a phosphocholine.

The term “phospholipids” as used herein refers to functional groups or molecules having a phosphate group and at least one long-chain alkyl, group. For example, phopholipids include lecithin.

The term “long-chain alkylamines” as used herein refers to functional groups or molecules having an amine group and at least one long-chain alkyl group, or suitable salts thereof. For example, oleylamine is a long-chain alkylamine of the disclosure.

The term “long-chain alkylacids” as used herein refers to functional groups or molecules having a carboxylate group and at least one long-chain alkyl group, or suitable salts thereof. For example, oleic acid, and suitable salts thereof, are long-chain alkylacids of the disclosure.

### EXAMPLES

The invention now being generally described, it will be more readily understood by reference to the following examples which are included merely for purposes of illustration of certain aspects and embodiments of the present invention, and are not intended to limit the invention.

### Example 1: Exemplary Synthetic Methods

### Materials:

PbBr2 (99.99%), MnCl2 (99.99%), ZnCl2 (98%), NiCl2 (98%), trioctylphosphine oxide (TOPO, 90%), Cs₂CO₃ (99%), Diisooctylphosphinic acid (DOPA, 90%), oleylamine (98%), and hydrochloric acid (37%) were ordered from Sigma-Aldrich. Hexane (97%, HPLC grade), acetone (99.5%) were ordered from VWR. Lecithin (97%, from soy), diethyl ether (99%, stabilized) were ordered from ThermoFisher. Octane (98%) was ordered from Beantown Chemicals. All reagents were used without further purification.

### Stock Solution Preparation

The XCl:PbBr2 stock solutions were prepared with different molar ratios (100:0, 95:5, 90:10, 80:20, 75:25, and 50:50) of XCl:PbBr₂ (X=Mn, Ni, and Zn). In general, W 1.25 mmol of TOPO, 0.2 mmol (total) of XCl:PbBr₂ were added to 1.25 ml of octane, where the temperature was raised to 120° C. for 1 hour. Upon cooling, 5 mL of hexanes were added. The trioctylphosphine oxide (TOPO) stock solution was prepared by dissolving 6 mmol of TOPO in 30 ml of hexane. The Cs₂CO₃ stock solution was prepared by adding 100 mg of Cs₂CO₃ to a vial with 1 ml of diisooctylphosphinate (DOPA) and 2 ml octane before heating for 60 min. at 120° C. Upon cooling, 27 ml hexane were added. The lecithin stock solution was prepared by dissolving lecithin in hexane in 50 mg/mL. All stock solutions were syringe filtered (13 mm diameter, 0.45 μm pore size) before NC synthesis.

### Oleylammonium Chloride Synthesis

12.5 mL of oleylamine and 100 mL were added to a flask and placed in an ice bath. 9.6 mL of HCl was added dropwise, and allowed to stir overnight. The oleylammonium chloride (OleyCl) salt was purified by washing with diethyl ether 3 times, and dried under vacuum overnight, yielding a white powder.

The OleyCl stock solution was prepared by dissolving OleyCl in toluene at a concentration of 10 mg/mL in toluene.

### General Nanocrystalline Halide Perovskite Synthesis

In a glass vial with a ml of hexane, β μl of a PbBr₂:X_{DOPANT}Cl₂ stock solution was added (where X_{DOPANT}=Mn, Zn, Ni) with a certain ratio γ (γ=100:0, 95:5, 90:10, 80:20, 75:25, 50:50, 25:75, or 0:100) and δ μL of the TOPO stock solution together with a small stirring bar. All stock solutions are agitated directly before usage for 10 s. at 2,500 rpm. The synthesis was started directly after adding the stock solutions into the glass vial filled with hexane. Up to six samples are placed on a stirring plate approx. 5 cm from the middle such that they are all stirred with the same intensity at ≈500 rpm. After 20 s. of mixing, εμl of Cs₂CO₃ is added to start the synthesis. After a certain time T, the synthesis is ended by adding εμl of lecithin solution. For chloride and bromide shifting (halide exchange), 1 ml of chloride or bromide salt (chosen depending on the halide desired in the resulting HP NC) was dissolved toluene or non-polar solvent solution 30 s. prior to adding lecithin.

The typical volumes used for each synthesis parameter are shown below in Table S1.

TABLE S1

| Parameter | Typical Range | |
|---|---|---|
| Hexane Volume, α | 1-12 | mL |
| Volume of PbBr₂ stock solution, β | 20-200 | μL |
| Ratio of Pb:X_{DOPANT} doping, γ | 100:0-50:50 | |
| TOPO stock solution volume added, δ | 0-360 | μL |
| Volume of Cs₂CO₃ stock solution, ε | 10-100 | μL |
| Reaction time, T | 1-30 | min |

Most syntheses performed fell into these typical ranges, but this synthesis works for higher quantities. For example, Mn-doped NCs scaled up by 50-100× typical quantities were successfully synthesized via this method, resulting in NCs synthesized on the 100-1000 mg scales with no change in their optical properties (indicating similar size characteristics).

### NC Purification

The synthesized NCs were added to a centrifuge tube, where 18 ml of acetone (approx. 3-fold excess) were added into the centrifuge tube. All tubes were centrifuged for 5 min. at 7480 rpm, corresponding to 5,500 g. After acetone was dispensed, the vials were dried for 4 min. Then, 1 ml of hexane was added to each centrifuge tube and agitated for 10 s to dissolve the nanocrystals. The NC solutions were finally passed through hydrophobic PTFE syringe filters (0.45 μm pore size with 13 mm in diameter). The final solution of nanocrystals dissolved in 1 ml of hexane was stored in small glass vials for later measurement.

### Steady-State Optical Characterization

UV-visible absorption spectra were collected using a Cary 5000 UV-Vis-NIR spectrophotometer using a spectral bandwidth of 2 nm. Steady-state PL spectra were collected using a CCS200/M spectrometer (ThorLabs) using a 365 nm LED (ThorLabs Solis365C) equipped with a 365 nm bandpass filter (Newport) to excite the samples. A 385 nm long pass filter (Newport) was placed after the sample to remove excess scatter from the excitation source. The 1 mL hexane redispersed samples were measured optically without further modification.

### Elemental Analysis

As-synthesized Mn-doped or metal-doped halide perovskite nanocrystals were first purified as normal, and then dried under vacuum for 1 hour to remove residual hexane. For elemental analysis via ICP-MS, the nanocrystals were digested in aqueous HNO₃ before the % Mn/Pb was determined using an ICP-MS:Agilent 7800.

### Transient Absorption (TA) Spectroscopy

TA was measured using a setup based on a 1030 nm seed laser (PHAROS, Light Conversion, Yb:KGW lasing medium, 400 μJ pulse energy, 150 fs duration, 50 kHz repetition rate). The 343 nm pump beam (800 μm in diameter) was generated from the first and second harmonics of the 1030 nm seed laser using a harmonic generation unit equipped with nonlinear crystals (beta-barium borate, lithium triborate). (HIRO, Light Conversion). The residual first and second harmonics were removed by dichroic mirrors. The third harmonic (343 nm) pump was passed through an optical chopper (100 Hz), where a portion of the pump was routed to a photodiode using a beam splitter in order to sort generated probe measurements into pumped and unpumped. The probe beam (200 μm in diameter) was generated from the second harmonic of the seed laser using quasi-supercontinuum generation in a sapphire crystal. The probe beam was passed into a grating spectrograph (Andor Kymera 193i) and recorded using a Si NMOS photodiode array detector (256 pixels). All TA experiments were conducted at pump fluences ˜3 μJ/cm2. NC samples were measured in a 1 mm path-length quartz cuvette (Hellma) at concentrations ˜0.5 μM.

### Time-Resolved Photoluminescence Measurements

Time-resolved photoluminescence was measured using time-correlated single photon counting (TCSPC). The 343 nm excitation sources were generated from a 1030 nm seed laser (PHAROS, Light Conversion, Yb:KGW lasing medium, 400 μJ pulse energy, 150 fs duration, 50 kHz repetition rate) using a harmonic generation unit equipped with beta-barium borate and lithium triborate nonlinear crystals (HIRO, Light Conversion). Upon photoexcitation, fluorescence from the sample was focused on a photomultiplier tube (Becker & Hickl HPM-100-07) positioned behind the exit slit of a monochromator, where photon counting occurred using the single photon counting module provided by Light Conversion. Nanocrystal Size Quantification

After purification and redispersal in hexane, the HP NCs were drop-casted onto a TEM grid. Micrographs were measured using a JEOL 2100 TEM. Edge lengths were determined using line profiles using ImageJ.

Further structural characterization was performed and the morphologies of samples with histogrammed sizes were collected using a JEOL ARM 200F TEM at 200 kV using a single tilt holder.

### Electron Paramagnetic Resonance (EPR)

X-band continuous-wave (CW) EPR spectra were recorded on a Bruker ElexSys E500 spectrometer. All spectra were recorded at room temperature as suspensions in hexane. Spectrometer settings were as follows: frequency=9.86 GHz, power=0.6325 mW, gain=20 dB, modulation amplitude=8.0 G, modulation frequency=100 kHz, 32 sweeps. All spectra were simulated using EasySpin to obtain effective g values and hyperfine coupling constants.

### Example 2: Exemplary Nanocrystalline Mn-Doped CsPbCl₃ Halide Perovskites Selected for TEM Imaging

TABLE S2

| | Molar Ratio of Pb:Mn in Stock Solution | | | | | | |
|---|---|---|---|---|---|---|---|
| | | 100:0 | 95:5 | 90:10 | 80:20 | 75:25 | 50:50 |
| TOPO | 360 | X | | | | | X |
| Added | 320 | | | | | | |
| (μL) | 280 | | | | | | |
| | 240 | X | | | X | | X |
| | 200 | | | | | | |
| | 160 | X | X | X | X | | X |
| | 120 | X | X | | X | X | X |

### Example 3: Absorbance Peak Maxima (λₘₐₓ in nm) for Exemplary Halide Shifted (X=Cl⁻) Nanocrystals

TABLE S3

| | | Molar Ratio of Pb:Mn in Stock Solution | | | | | |
|---|---|---|---|---|---|---|---|
| | | 100:0 | 95:5 | 90:10 | 80:20 | 75:25 | 50:50 |
| TOPO | 360 | 402.25 | 399.25 | 386.75 | 387.5 | 386.75 | 388.25 |
| Added | 320 | 402.5 | 398.0 | 385.25 | 387.75 | 388 | 388.25 |
| (μL) | 280 | 404 | 396 | 395.5 | 390.25 | 389 | 392 |
| | 240 | 399.25 | 395.25 | 392.75 | 392.5 | 391.5 | 390.25 |
| | 200 | 397.5 | 394.25 | 392.75 | 392.5 | 397 | 391 |
| | 160 | 395.25 | 392.75 | 392.5 | 392.5 | 395.25 | 390.5 |
| | 120 | 393.25 | 390.75 | 388.75 | 389.0 | 390.75 | 390.5 |

### Example 4: Absorbance Peak Maxima (λₘₐₓ in nm) for Exemplary Non-Halide Shifted (X=Mixture of Cl/Br) Nanocrystals

TABLE S4

| | | Molar Ratio of Pb:Mn in Stock Solution | | | | | |
|---|---|---|---|---|---|---|---|
| | | 100:0 | 95:5 | 90:10 | 80:20 | 75:25 | 50:50 |
| TOPO | 360 | 501.5 | 489.75 | 475.25 | 445.5 | 440.5 | 430.25 |
| Added | 320 | 501.5 | 484.5 | 473 | 455.25 | 442.25 | 417.5 |
| (μL) | 280 | 497.5 | 482.25 | 470 | 459.5 | 447.25 | 418.75 |
| | 240 | 496 | 480.5 | 467.5 | 453.25 | 446.25 | 418.75 |
| | 200 | 489 | 472.5 | 463.25 | 451.5 | 445.74 | 424 |
| | 160 | 484.25 | 484.5 | 461.75 | 465.5 | 451.5 | 445.25 |
| | 120 | 473 | 469.25 | 472 | 466 | 450.5 | 429.25 |

### Example 5: Emission Peak Maxima (λₘₐₓ in nm) for Exemplary Halide Shifted (X=Cl⁻) Nanocrystals

TABLE S5

| | | Molar Ratio of Pb:Mn in Stock Solution | | | | | |
|---|---|---|---|---|---|---|---|
| | | 100:0 | 95:5 | 90:10 | 80:20 | 75:25 | 50:50 |
| TOPO | 360 | 405.25 | 404.28 | 403.72 | 403.72 | 403.07 | 403.07 |
| Added | 320 | 406.34 | 404.16 | 403.07 | 403.94 | 403.07 | 401.98 |
| (μL) | 280 | 410.5 | 403.07 | 403.72 | 403.07 | 403.07 | 405.47 |
| | 240 | 404.38 | 403.07 | 401.98 | 401.98 | 403.07 | 401.98 |
| | 200 | 403.07 | 401.98 | 401.98 | 401.98 | 404.38 | 401.98 |
| | 160 | 403.07 | 401.1 | 403.07 | 403.07 | 404.38 | 401.98 |
| | 120 | 401.98 | 398.92 | 397.18 | 398.98 | 401.1 | 401.1 |

### Example 6: Emission Peak Maxima (λₘₐₓ in nm) for Exemplary Non-Halide Shifted (X=Mixture of Cl/Br) Nanocrystals

TABLE S6

| | | Molar Ratio of Pb:Mn in Stock Solution | | | | | |
|---|---|---|---|---|---|---|---|
| | | 100:0 | 95:5 | 90:10 | 80:20 | 75:25 | 50:50 |
| TOPO | 360 | 508.75 | 499.62 | 489.17 | 470.55 | 459.94 | 439.44 |
| Added | 320 | 508.31 | 494.5 | 485.62 | 469.66 | 459.94 | 431.75 |
| (μL) | 280 | 504.07 | 491.84 | 481.63 | 472.32 | 459.94 | 431.52 |
| | 240 | 503.18 | 490.5 | 480.96 | 464.8 | 458.39 | 431.53 |
| | 200 | 496.95 | 484.95 | 477.64 | 464.58 | 457.95 | 421.88 |
| | 160 | 494.06 | 496.51 | 480.96 | 466.13 | 458.39 | 431.75 |
| | 120 | 490.06 | 486.06 | 487.4 | 478.08 | 463.92 | 438.12 |

### Example 7: Absorbance and Emission Peak Maxima (λₘₐₓ in nm) for Exemplary Zn-Doped CsPbCl₃ Perovskite Nanocrystals

TABLE S7a
Absorbance Peak Maxima (λₘₐₓ in nm).

Molar Ratio of Pb:Zn in Stock Solution

| | | 100:0 | 90:10 | 80:20 | 50:50 |
|---|---|---|---|---|---|
| TOPO | 360 | 402.25 | 401.25 | 394.75 | 392.75 |
| Added | 240 | 400.25 | 401.25 | 394.75 | 396.75 |
| (μL) | 120 | 392.25 | 395.25 | 393.25 | 396.25 |

TABLE S7b
Emission Peak Maxima (λₘₐₓ in nm).

Molar Ratio of Pb:Zn in Stock Solution

| | | 100:0 | 90:10 | 80:20 | 50:50 |
|---|---|---|---|---|---|
| TOPO | 360 | 412.8 | 413.9 | 415.5 | 408.9 |
| Added | 240 | 411.8 | 411 | 410.2 | 409.6 |
| (μL) | 120 | 408.1 | 406.2 | 406.2 | 410.7 |

### Example 8: Absorbance and Emission Peak Maxima (λₘₐₓ in nm) for Exemplary Ni-Doped CsPbCl₃ Perovskite Nanocrystals

TABLE S8a
Absorbance Peak Maxima (λₘₐₓ in nm).

Molar Ratio of Pb:Ni in Stock Solution

| | | 100:0 | 90:10 | 80:20 | 50:50 |
|---|---|---|---|---|---|
| TOPO | 360 | 404.25 | 404.25 | 397.25 | 389.25 |
| Added | 240 | 404.25 | 404.25 | 399.5 | 395.5 |
| (μL) | 120 | 397.5 | 394.5 | 393.5 | 396.25 |

TABLE S8b
Emission Peak Maxima (λₘₐₓ in nm).

Molar Ratio of Pb:Ni in Stock Solution

| | | 100:0 | 90:10 | 80:20 | 50:50 |
|---|---|---|---|---|---|
| TOPO | 360 | 412.3 | 411.8 | 407.5 | 406.7 |
| Added | 240 | 408.9 | 410.2 | 407 | 410.7 |
| (μL) | 120 | 406.7 | 408.1 | 407.5 | 407 |

### Example 9: Inductively Coupled Plasma-Mass Spectrometry Analysis of Exemplary Nanocrystalline Mn-doped CsPbCl₃ Halide Perovskites

TABLE S9a
Exemplary Nanocrystalline Mn-doped
CsPbCl₃ Halide Perovskites Selected for Inductively
Coupled Plasma-Mass Spectrometry Analysis

| | | Molar Ratio of Pb:Mn in Stock Solution | | | | | |
|---|---|---|---|---|---|---|---|
| | | 100:0 | 95:5 | 90:10 | 80:20 | 75:25 | 50:50 |
| TOPO | 360 | X | X | X | | | X |
| Added | 320 | | | | | | |
| (μL) | 280 | | | | | | |
| | 240 | X | | X | | | X |
| | 200 | | | | | | |
| | 160 | | | | | | |
| | 120 | X | X | X | | X | X |

TABLE S9b
Results of Inductively Coupled Plasma-Mass
Spectrometry Analysis of Exemplary Nanocrystalline
Mn-doped CsPbCl₃ Halide Perovskites

| TOPO Vol. | Pb:Mn Ratio | |
|---|---|---|
| (μL) | (pre-synthesis) | % Mn (relative to Pb) |
| 120 | 95:5 | 0.062% |
| 360 | 95:5 | 0.103% |
| 120 | 90:10 | 0.111% |
| 240 | 90:10 | 0.189% |
| 360 | 90:10 | 0.187% |
| 120 | 75:25 | 0.297% |
| 360 | 75:25 | 0.298% |
| 120 | 50:50 | 0.477% |
| 240 | 50:50 | 0.502% |
| 360 | 50:50 | 0.468% |

### Example 10: Edge Length Characterization of Exemplary Mn-Doped Halide Perovskite Nanocrystal Compositions

### 120 μL TOPO Stock Solution

TABLE S10a

| Pb:Mn | | | | | |
|---|---|---|---|---|---|
| Ratio (pre- | | | | | Std. |
| synthesis) | D90 | D70 | D50 | Mean | Dev. |
| 100:0 | 6.53 | 5.88 | 5.42 | 5.51 | 0.87 |
| 95:5 | 7.20 | 5.77 | 5.12 | 5.31 | 1.24 |
| 80:20 | 7.18 | 6.21 | 5.66 | 5.64 | 1.17 |
| 75:25 | 6.96 | 6.26 | 5.78 | 5.85 | 0.95 |
| 50:50 | 8.61 | 7.20 | 6.60 | 6.76 | 1.27 |

### 160 μL TOPO Stock Solution

TABLE S10b

| Pb:Mn Ratio | | | | | Std. |
|---|---|---|---|---|---|
| (pre-synthesis) | D90 | D70 | D50 | Mean | Dev. |
| 100:0 | 7.24 | 6.28 | 5.76 | 5.92 | 0.95 |
| 95:5 | 6.84 | 5.97 | 5.49 | 5.58 | 1.06 |
| 90:10 | 6.91 | 6.40 | 6.03 | 6.00 | 0.73 |
| 80:20 | 6.04 | 5.43 | 5.03 | 5.03 | 0.80 |
| 50:50 | 6.75 | 6.04 | 5.60 | 5.64 | 0.92 |

### 240 μL TOPO Stock Solution

TABLE S10c

| Pb:Mn Ratio | | | | | Std. |
|---|---|---|---|---|---|
| (pre-synthesis) | D90 | D70 | D50 | Mean | Dev. |
| 100:0 | 7.39 | 6.56 | 6.22 | 6.23 | 0.83 |
| 80:20 | 6.98 | 6.10 | 5.46 | 5.53 | 1.15 |
| 50:50 | 7.39 | 6.65 | 6.034 | 6.06 | 1.08 |

### 360 μL TOPO Stock Solution

TABLE S10d

| Pb:Mn Ratio | | | | | Std. |
|---|---|---|---|---|---|
| (pre-synthesis) | D90 | D70 | D50 | Mean | Dev. |
| 100:0 | 12.12 | 10.97 | 9.95 | 9.91 | 1.76 |
| 50:50 | 13.35 | 11.35 | 10.23 | 10.66 | 2.18 |

### Example 11: Results and Discussion of a Mn-Doped as an Example Case

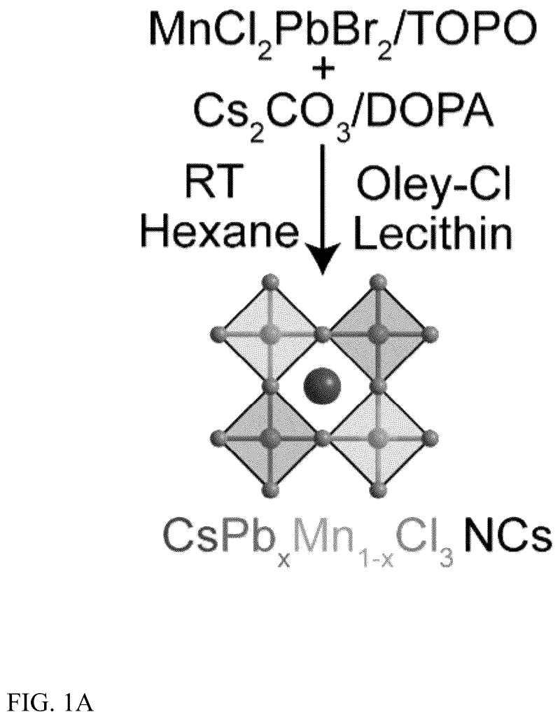

At first, it has to be emphasized that the methods of the disclosure can be generalized to other metallic dopant such as Ni or Zn. Mn-doped NCs, which are an exemplary case, are examined more specifically below. Size-tunable doped nanocrystals were synthesized according to the methods of the disclosure, using the above-described mole ratios and various amounts of TOPO added to precisely tune the Mn concentration and NC size, respectively. Upon the addition of Mn, the pure-chloride-doped NCs feature the expected pronounced blue shift in their excitonic absorption (FIG. 1B), and photoluminescence (PL) (FIG. 1C) compared to their undoped equivalents (see also FIGS. 3A-3B and FIGS. 9A-9B for Ni-doping and Zn-doping). This dopant-induced bandgap widening, which occurs in addition to that due to the bromide-to-chloride shift and the quantum confinement for a given size, was previously attributed to local NC lattice periodicity breaking caused by the electronic perturbation of the dopant. To verify that all doped and undoped NCs are indeed the same size, transmission electron microscopy (TEM) was performed for various sizes, resulting in similar mean NC edge lengths for doped and undoped NCs. Further, the Mn-dopant concentration in the final NC products was verified using ICP-MS for a variety of Mn-dopant feed ratios and NC sizes. An excess of Mn is necessary for the synthesis of Mn-doped NCs. Interestingly, two doping regimes are observed, where for Pb:Mn doping ratios with less Mn (95:5 and 90:10), the final Mn concentration (relative to Pb) depends on the NC size, with larger NCs incorporating relatively more Mn. At higher Mn doping ratios (75:25 and 50:50), the Mn concentration is size-independent, resulting in a high maximal doping concentration of ˜1.8 atomic-% at a 50:50 Pb:Mn doping ratio. Careful observation of the smaller NC sizes in the absorption spectra in FIG. 1B yields a slight red shift upon increasing Mn concentration. This is a size effect, where for small NC sizes and relatively high Mn concentrations, the mean NC size was relatively larger than the undoped NC. In concert with a general blue shift in the excitonic NC PL upon doping (FIG. 1c), a broad emission can be observed around 600 nm, increasing in intensity relative to the excitonic PL for higher concentrations of Mn.

When the halide anion is not shifted during synthesis, the host excitonic absorption and emission blue shift with higher Mn doping ratios due to a higher chloride content brought in, rather than the impact of the metal dopant. In the not fully halide-shifted case (i.e., largely bromide-rich Mn-doped CsPbX₃ with only small amounts of chloride content), no Mn significant emission is observed.

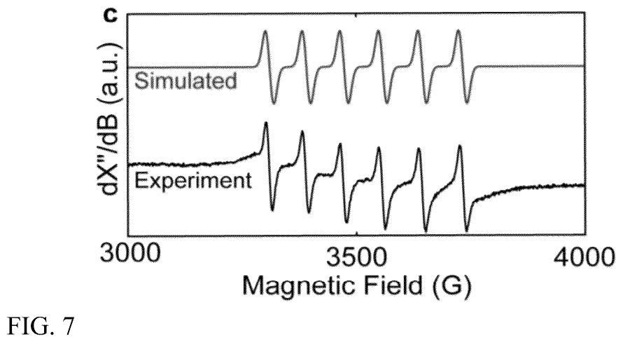

The NC size and shape remain again largely unchanged upon doping, as shown by TEM (FIG. 2A-2D), confirming that the blue shift observed in FIG. 1B is not correlated with the NC size, but due to the dopant. Additionally, X-band EPR of 1.8% Mn-doped NCs (FIG. 8B) yielded a signal at g≈2 with the expected splitting pattern of an S=½ system coupled to a 55Mn (I=5/2) nucleus. Simulation with EasySpin yielded a hyperfine coupling constant of 55Mn(A)=85 G (or 238 MHZ), which is similar to the hyperfine coupling constant observed in bulk Mn-doped CsPbCl₃ (87 G) signifying that the Mn incorporates into the NC lattice. X-ray diffraction patterns of the synthesized undoped and Mn-doped NCs correspond to observed patterns for orthorhombic CsPbCl₃ NCs. No significant difference between undoped and 1.8% Mn-doped NCs is observed. Thus, the small dopant concentration has largely negligible effects on the average lattice spacing, despite the smaller ionic radii of Mn as compared to Pb.

The ability to precisely synthesize size- and doping-level-tunable NCs allows for the elucidation of their photophysical properties in a systematical manner allowing decoupling effects due to dopant incorporation or halide composition from those of quantum confinement. Accordingly, the dynamics of charge recombination and energy transfer to Mn centers in Mn-doped CsPbX₃ NCs have been studied through a combination of time-resolved optical spectroscopies, providing insights on carrier trapping, radiative recombination, energy/charge transfer to Mn, and Auger-like processes.

FIG. 8A shows a representative set of transient absorption (TA) spectra for a CsPbCl₃ NC ensemble in solution for various pump-probe delays, excited at 343 nm (ca. 100 fs long pulses).

In all spectra, three dominant features can be observed: i) a negative feature corresponding to the excitonic ground state bleach (GSB), attributed to carrier filling upon excitation, ii) a positive photoinduced absorption (PIA) feature blue-shifted from the GSB, and iii) another PIA red-shifted from the GSB. The positive feature red-shifted from the GSB is commonly attributed to the presence of biexcitons. In our analysis, we focus on the ground-state exciton bleach and plot the kinetics at the respective maximum for each undoped NC size in FIG. 8C.

We observe largely multi-exponential appearing kinetics for all cases, which can be understood from the ensemble character of the nanocrystals having a distribution of respective sizes and trap densities (e.g. a different propensity of surface traps between two NCs in the solution). Therefore, we refrain here from the unphysical assignment of lifetimes from multi-exponential fits to specific processes but note that generally charge trapping has been assigned to occur often on few-ps timescales, energy-transfer from host to dopant on a few-hundred ps timescale, radiative recombination on the sub-ns to few-ns timescale, and delayed trap-assisted recombination on the order of hundreds of ns. Following this, the initially similar drop within the first few ps for all sizes of undoped NCs (FIG. 8C) implies a similar amount of charge trapping and thus (surface-) trap density for all sizes produced. Similarly, the late-time decay tails assigned to trap-assisted recombination at the latest times remain largely unaffected by the NC size. However, the major decay component covering the range from tens of ps to about 1 ns varies strongly across the sizes and becomes faster for larger NCs. As this timescale corresponds mostly to intrinsic radiative recombination, we expected this trend to be a consequence of the “giant oscillator strength effect”, meaning that upon entering the weak confinement regime, the radiative lifetime dramatically shortens. When next turning to a series of 1.8% Mn-doped CsPbCl₃ NCs of various sizes, we find the kinetics to change dramatically (FIG. 8C). Very interestingly, we observed near-identical kinetics for the various NC sizes upon doping. This “pinning” of kinetics, which to the best of our knowledge has not been observed before (due to the absence of a synthesis method to produce such a series so far), indicates a rate-determining step due to the presence of the dopant which surpasses the effect of quantum confinement, or its absence. We related this observation again to the lattice-periodicity breaking of the dopant, an effective perturbation that prevents the delocalization of the exciton wave function across the whole nanocrystal volume, and also its modulation due to the quantum size effect.

Further, we use TA to elucidate differences in the surface dynamics to monitor the effects of the different chloride-shifting agents. We measured TA kinetics taken from the GSB maxima for undoped and 1.8% Mn-doped CsPbCl₃ NCs chloride shifted with oleylammonium chloride or WCl6/TOPO. In both cases, the recovery lessened in the first 5 ps, the timescale typically attributed to rapid carrier trapping in CsPbCl₃ NCs. Therefore, we attribute the slower bleach recovery to a higher degree of surface passivation when oleylammonium chloride is used. The excess amines allow for tighter cationic ligand binding. It is important to note though, that the injection of oleylammonium chloride also forms additional species present in solution, which can be visible in the UV-Vis absorbance. These species probably are 2D layered Pb-halide species formed under an excess of oleylamine. These species can be separated by employing slightly longer mixing times (after ligand addition) and by syringe filtering the NC solution. Therefore, the anion-shifting agent can be chosen to reflect the priority for ease in synthesis (WCl6/TOPO), or for a higher degree of surface passivation (oleylammonium chloride), based on application requirements.

As the methods of this disclosure can be generalized, HP NCs were doped with Ni²⁺ or Zn²⁺ dopants. FIGS. 9A-9B depicts the absorption spectra of metal doped CsPbCl₃ NCs synthesized with Ni²⁺ or Zn²⁺ dopants at the same molar ratios as in the case of Mn-dopant. For both exemplary NC sizes shown in each case, the metal-doped NCs feature a distinct optical blue shift upon metal doping. Similarly to the Mn-doped case, this is not a size or halide composition effect, as the mean sizes of undoped and doped NCs are similar and an excess of chloride anion is added in all cases to fully shift to a pure-chloride composition. This optical blue-shift instead arises from the bandgap opening due to the same, element-unspecific lattice-periodicity breaking effect. Such alternative dopants are particularly exciting for light-emitting applications, as Ni and Zn can increase the radiative rate of these NCs and push their emission wavelength to the near-UV, especially when now combinable with the access to the strong confinement regime, but without featuring an additional decay channel towards the broad, slow orange additional emission as Mn does.

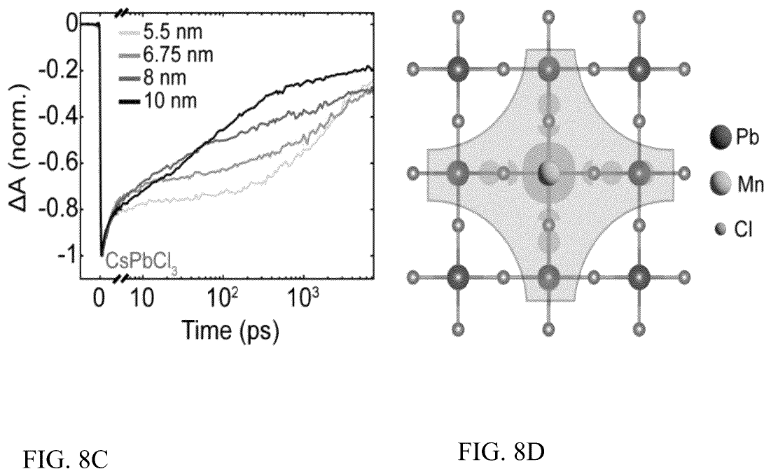

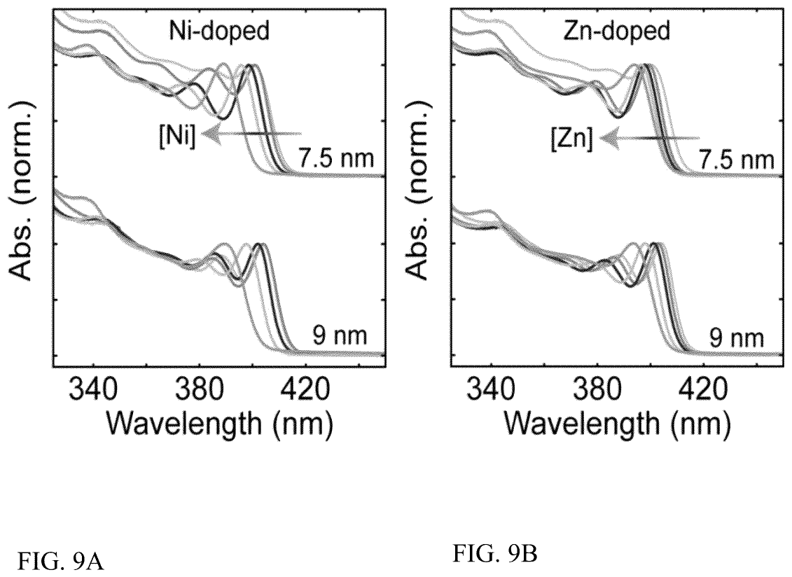

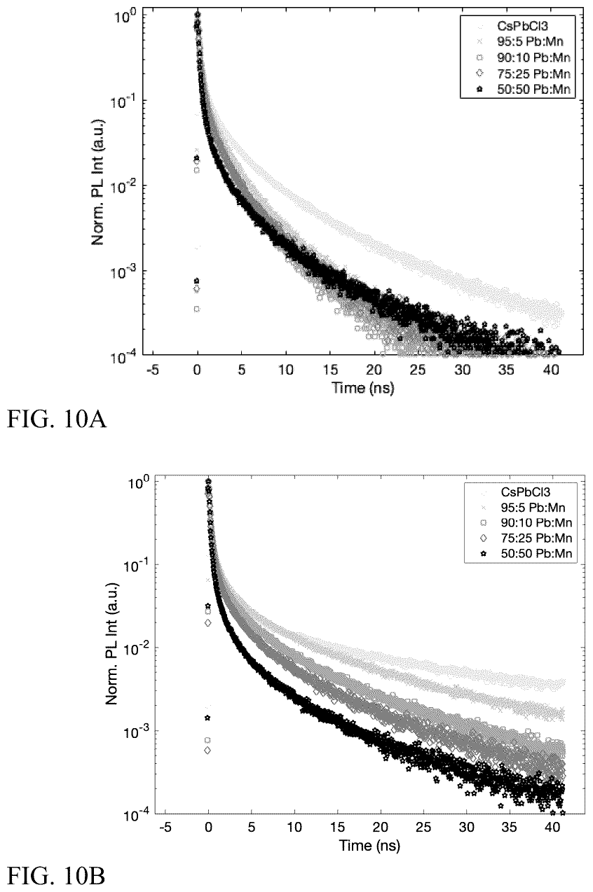

The synthetic method of the disclosure allows for photophysical investigations into doped perovskite nanocrystals at size and dopant concentration ranges that have not been able to be reached previously. We observed a difference in the optical properties over time in undoped and doped nanocrystals with different sizes across multiple timescales, for example. First, using time-resolved photoluminescence (PL) measurements in the form of time-correlated single photon counting, we observed the PL decay rapidly in the presence of Mn-dopants, where we attributed this to energy transfer to Mn d-d states upon nanocrystal excitation. Importantly, the rates of energy transfer change depending on the nanocrystal size as it can be observed from the comparison between FIG. 10A and FIG. 10B. Interestingly, the energy transfer changes more gradually in the case of larger nanocrystals (FIG. 10B). The unique ability to drastically change the NC size and dopant concentration independently therefore allows for the elucidation of the resultant optical properties upon the incorporation of metal dopants. The energy transfer rates to Mn-states are also composition-dependent. FIG. 11 and FIG. 12 illustrate PL decays of the same-sized CsPbCl₃ nanocrystals (FIG. 11), and mixed halide CsPbBr/Cl₃ nanocrystals (FIG. 12). Despite the much longer native CsPbBr₃ lifetime, there is still significant PL quenching, due to transfer to Mn, showing the impact of Mn, even though the PL emission is essentially not observed when the halide ions are not fully shifted to the Cl case.

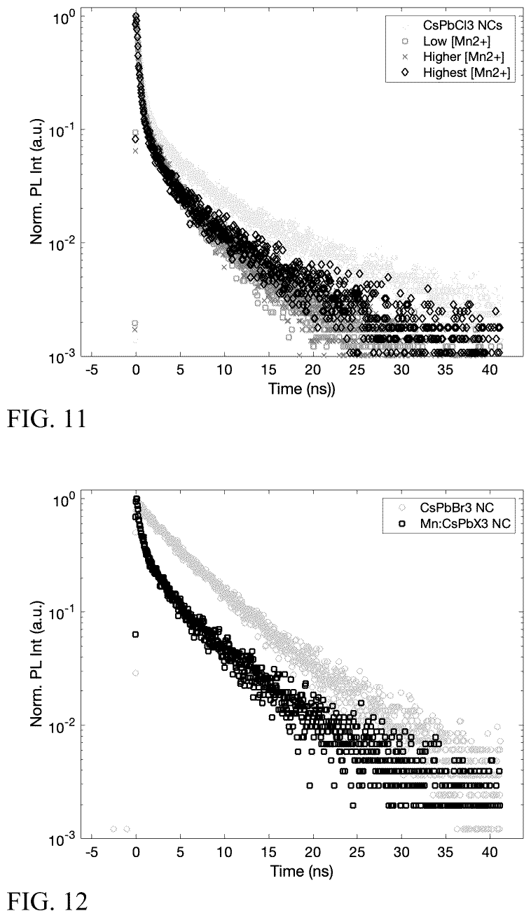

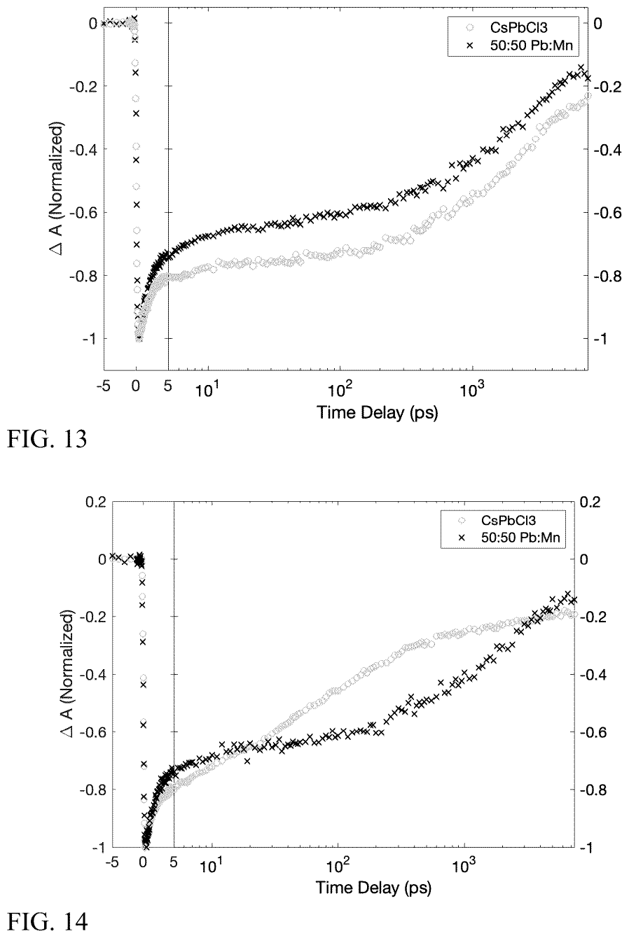

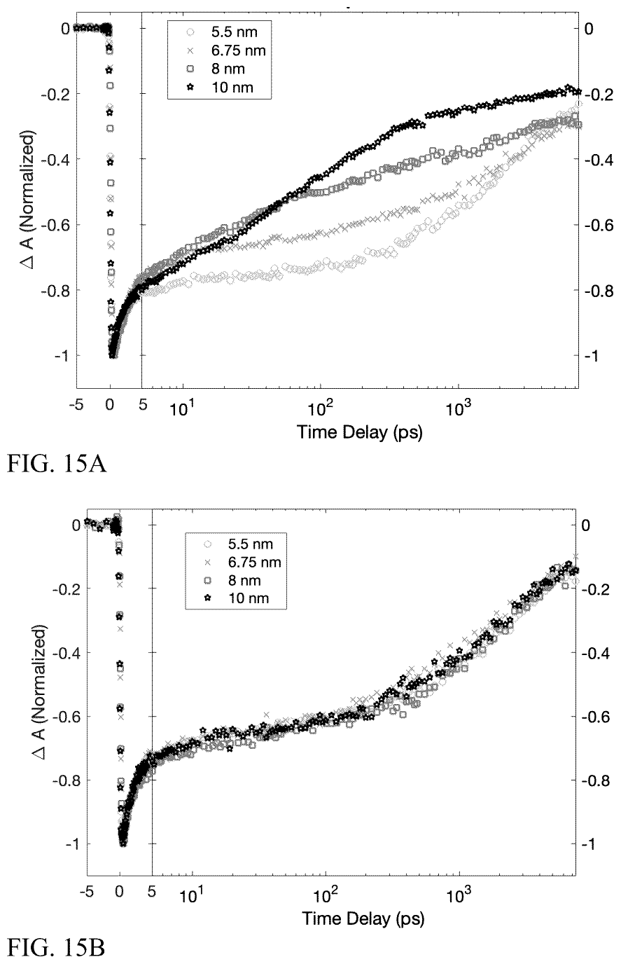

Additionally, the ultrafast photophysical phenomena of doped and undoped perovskite nanocrystals have been observed using ultrafast transient absorption. Transient absorption allows for the elucidation of spectral and temporal dynamics in the excited states of both undoped and doped perovskite nanocrystals. We observed a larger difference in the ground state bleach kinetics of smaller perovskite nanocrystals, when the undoped nanocrystals are compared directly to Mn-doped perovskite nanocrystals with a 50:50 Pb:Mn doping ratio (FIG. 13). The largest difference occurs in the timescale of hundreds of picoseconds, a range wherein excitonic recombination in CsPbCl₃ nanocrystals is expected to be observed. In the case of smaller nanocrystals (FIG. 13), a more rapid recovery of the exciton bleach in doped CsPbCl₃ nanocrystals is observed, indicating a more rapid excitonic recombination. For larger nanocrystals, however, this trend is reversed, with the undoped nanocrystal decaying much faster at these intermediate times (FIG. 14). Interestingly, the differences in these kinetics are observed in the undoped NCs (FIG. 15A), where the excitonic recombination speeds up with the increase in size of the undoped nanocrystal, likely due to the observation of a giant oscillator strength effect of the larger nanocrystals. Interestingly, though, the nanocrystals doped with a Pb:Mn doping ratio of 50:50 show identical kinetics (FIG. 15B), an effect we attribute to a dopant-induced excitonic localization effect. It is important to note that these effects have not been previously elucidated using transient absorption, and are now only accessible due to the synthetic methods of this disclosure.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A method of preparing a composition comprising crystalline particles of a first halide perovskite, the method comprising the steps of:
combining an A-site stock solution comprising:
an A-site complex comprising an A-site precursor and an A-site complexing agent; and
a first non-polar solvent;
with a B-site stock solution comprising:
a B-site complex comprising a lead (II) halide, a dopant halide, a B-site complexing agent; and
a second non-polar solvent;
in a third non-polar solvent, under conditions suitable for the formation of a first product mixture, comprising the crystalline particles of a first halide perovskite, the first halide perovskite having a chemical formula according to Formula I:
ABX₃ (I);
wherein:
A is a monocation selected from a metallic element and a monocationic organic group;
B is selected from a combination of Pb²⁺ and a dopant;
X, independently at each occurrence, is a halide;
and further wherein:
the A-site precursor is a salt of A, which is soluble in the first non-polar solvent;
the A-site complexing agent and the B-site complexing agent are each selected from a molecule comprising at least one non-polar hydrocarbyl group and at least one polar group;
the dopant is a dication of a metallic element or a trication of a metallic element.

2. The method of any one of claim 1, wherein A is selected from the group consisting of Li⁺, Na⁺, K⁺, Rb⁺, and Cs⁺ or from the group consisting of methylammonium [(CH₃NH₃)⁺], formamidinium [(HC(NH₂)₂⁺], ethylammonium [(H₅C₂NH₃)⁺], butylammonium [(H₉C₄NH₃)⁺], and guanidinium [C(NH₂)₃⁺].

3. The method of claim 1, wherein the dopant is selected from the group consisting of Sn²⁺, Cd²⁺, Zn²⁺, Mn²⁺, Sr²⁺, Ni²⁺, Fe²⁺, Mn²⁺, Zn²⁺, Ni²⁺, Sr²⁺, Ca²⁺, Sm²⁺, Eu²⁺, and Co²⁺ or from the group consisting of Eu³⁺, Bi³⁺, In³⁺, Yb³⁺, Ce³⁺, Er³⁺, Sm³⁺, Eu³⁺, Tb³⁺, and Dy³⁺.

4. The method of claim 1, wherein the B-site stock solution comprises a combination of Pb²⁺ and a dopant in a molar ratio of Pb²⁺ relative to dopant of from about 95:5 to about 50:50.

5. The method of claim 1, wherein the halide perovskite comprises the dopant in an atomic ratio of from about 1:10000 to about 1:100 relative to Pb²⁺.

6. The method of claim 1, wherein X, independently at each occurrence, is selected from Cl, Br, and I.

7. The method of claim 1, wherein X, independently at each occurrence, is selected from Cl and Br.

8. The method of claim 1, wherein the first non-polar solvent, second non-polar solvent, and third non-polar solvent are each independently selected from a C₅-C₁₀ hydrocarbon, or is a mixture thereof.

9. The method of claim 1, wherein the method is carried out at room temperature.

10. The method of claim 1, further comprising:
contacting the first product mixture with a halide exchange solution;
wherein the halide exchange solution comprises:
a halide exchange reagent, the halide exchange reagent comprising an additional halide; and
a fourth non-polar solvent;
under conditions suitable to exchange at least one halide ion of the first halide perovskite with the additional halide;
thereby forming a second product mixture comprising crystalline particles of a second halide perovskite, wherein the second halide perovskite has a chemical formula according to Formula (I), and further wherein, each occurrence of X is the same halide.

11. The method of claim 10, wherein the halide exchange reagent is selected from an oleylammonium halide and WCl₆.

12. The method of claim 10, wherein the halide exchange reagent is selected from oleylammonium chloride, oleylammonium bromide, oleylammonium iodide and WCl₆.

13. The method of claim 10, wherein the fourth non-polar solvent is independently selected from a C₅-C₁₀ hydrocarbon, or is a mixture thereof.

14. The method of claim 10, wherein the second product mixture comprises the A-site complexing agent, the B-site complexing agent, and the second halide perovskite; and the method further comprises:
contacting the second product mixture with a ligand exchange solution, the ligand exchange solution comprising:
at least one ligand; and
a fifth non-polar solvent;
under conditions suitable to exchange the A-site complexing agent and/or the B-site complexing agent with the at least one ligand, thereby forming a third product mixture comprising ligated crystalline particles of the second halide perovskite;
wherein the ligated crystalline particles each have an outer surface, and each of the ligated crystalline particles further comprises at least one ligand bonded to the outer surface of the ligated crystalline particle.

15. The method of claim 14, wherein the at least one ligand is a molecule comprising at least one non-polar hydrocarbyl group and at least one zwitterionic group.

16. The method of claim 14, wherein the at least one ligand is selected from the group consisting of long chain sulfobetaines, phosphocholines, phospholipids, long-chain alkylamines, and long-chain alkylacids.

17. The method of claim 14, wherein the at least one ligand is lecithin.

18. The method of claim 14, wherein the fifth non-polar solvent is independently selected from a C₅-C₁₀ hydrocarbon, or is a mixture thereof.

19. The method of claim 14, wherein the method further comprises isolating the ligated crystalline particles from the third product mixture.

20. A composition comprising ligated crystalline particles of a halide perovskite obtained according to the method of claim 19 having an edge length of less than about 9 nm.

21. A perovskite-based device comprising ligated crystalline particles of a halide perovskite obtained according to the method of claim 19 and being selected from an optoelectronic device, a photoelectrochemical device, a sensor, a nanoscale magnet and a quantum material-based spintronic device.

22. The perovskite-based device according to claim 21, wherein the ligated crystalline particles of a halide perovskite have an edge length of less than about 9 nm.
